(19) United States
(12) Patent Application Publication
(10) Pub. No.: US 2023/0295416 A1
(43) Pub. Date: Sep. 21, 2023

(54) ONE-PART CURABLE RESIN COMPOSITION AND ADHESIVE

(71) Applicant: KANEKA CORPORATION, Osaka (JP)

(72) Inventor: Toshihiko Okamoto, Hyogo (JP)

(73) Assignee: KANEKA CORPORATION, Osaka (JP)

(21) Appl. No.: 18/202,649

(22) Filed: May 26, 2023

Related U.S. Application Data
(63) Continuation of application No. PCT/JP2021/043253, filed on Nov. 25, 2021.

(30) Foreign Application Priority Data
Nov. 27, 2020 (JP) 2020-197247
Jul. 1, 2021 (JP) 2021-109918

(51) Int. Cl. C08L 63/00; C09J 163/00; C09J 11/06; C09J 11/08; C08L 51/08

(52) U.S. Cl. CPC C08L 63/00; C09J 163/00; C09J 11/06; C09J 11/08; C08L 51/08; C08L 2207/53

(57) ABSTRACT

A one-part curable resin composition contains 100 parts by weight of an epoxy resin (A), 1 to 100 parts by weight of core-shell-structured polymer particles and/or blocked urethane as a component (B), a compound (C) having one to three phenolic hydroxy groups per molecule, the compound (C) not being a compound having an amino group; and dicyandiamide (D). The ratio of the number of moles of the phenolic hydroxy groups of the compound (C) to the number of moles of CN groups derived from the dicyandiamide (D) is from 0.01 to 0.39 when the compound (C) has one phenolic hydroxy group per molecule and from 0.01 to 1.5 when the compound (C) has two or three phenolic hydroxy groups per molecule.

### TECHNICAL FIELD

One or more embodiments of the present invention relate to a one-part curable resin composition containing an epoxy resin and an adhesive containing the one-part curable resin composition.

### BACKGROUND

Cured products of epoxy resins excel in many properties such as dimensional stability, mechanical strength, electrical insulation performance, heat resistance, water resistance, and chemical resistance. As such, epoxy resins are widely used in various products such as materials for civil engineering and construction, electrical or electronic materials, and adhesives. However, cured products of epoxy resins have the disadvantage of having low fracture toughness and exhibiting a very brittle behavior.

Dicyandiamide forms cyanamide when heated. This enables dicyandiamide to function as a latent curing agent that exhibits activity as a curing agent. Thus, it is known that a one-part curable composition can be produced by blending an epoxy resin with dicyandiamide.

Patent Literature 1 describes an adhesive composition that contains an epoxy resin, dicyandiamide serving as a curing agent, and fine particles made of a particular thermoplastic resin and having a particular particle size and that can thus exhibit high peel bond strength. In this literature, core-shell particles are used in Comparative Examples.

Patent Literature 2 describes a one-part epoxy adhesive prepared by blending an epoxy compound including a liquid epoxy having three or more functional groups with a filler, a core-shell toughener, and a latent curing agent such as dicyandiamide.

Patent Literature 3 describes an epoxy resin composition that contains an epoxy resin, an amino curing agent such as dicyandiamide, and a phenolic curing agent having a particular structure and in which the ratio between the amino and phenolic curing agents is within a particular range. This literature further describes prepregs formed using the epoxy resin composition.

### PATENT LITERATURE

PTL 1: Japanese Laid-Open Patent Application Publication No. 2005-36095
PTL 2: Japanese Laid-Open Patent Application Publication No. 2019-11445
PTL 3: Japanese Laid-Open Patent Application Publication No. 2001-40069

One-part curable compositions as described in Patent Literatures 1 to 3, each of which contains an epoxy resin blended with dicyandiamide, are unsatisfactory in terms of impact peel performance and leave room for improvement.

In view of the above circumstances, one or more embodiments of the present invention aims to provide a one-part curable resin composition that contains an epoxy resin and dicyandiamide and that cures into a cured product that exhibits high impact peel performance.

### SUMMARY

As a result of intensive studies with the goal of solving the above, the present inventors have found that when an epoxy resin (A) is blended with core-shell-structured polymer particles and/or blocked urethane (B), a particular phenolic compound (C), and dicyandiamide (D) in particular proportions, a one-part curable resin composition can be obtained that cures into a cured product that exhibits high impact peel performance.

Specifically, one or more embodiments of the present invention relate to a one-part curable resin composition containing:
100 parts by weight of an epoxy resin (A);
1 to 100 parts by weight of core-shell-structured polymer particles and/or blocked urethane (B);
a compound (C) having one to three phenolic hydroxy groups per molecule, the compound (C) not being a compound having one to three phenolic hydroxy groups per molecule and further having an amino group; and
dicyandiamide (D), wherein
a ratio of the number of moles of the phenolic hydroxy groups of the compound (C) to the number of moles of CN groups derived from the dicyandiamide (D) is from 0.01 to 0.39 when the compound (C) has one phenolic hydroxy group per molecule and from 0.01 to 1.5 when the compound (C) has two or three phenolic hydroxy groups per molecule.

The compound (C) may have one or two phenolic hydroxy groups per molecule.

The compound (C) may have one to four substituents on an aromatic ring, each of the substituents being selected from the group consisting of a methyl group, a primary alkyl group, a secondary alkyl group, a tertiary alkyl group, and a halogen.

The compound (C) may have one or two substituents at ortho positions relative to at least one phenolic hydroxy group, each of the substituents being selected from the group consisting of a methyl group, a primary alkyl group, a secondary alkyl group, a tertiary alkyl group, and a halogen.

The core-shell-structured polymer particles may be contained as the component (B).

The compound (C) may have a molecular weight of 90 to 500.

The one-part curable resin composition may further contain a compound (E) having four or more phenolic hydroxy groups per molecule, and a ratio of a total weight of the compound (E) to a total weight of the compound (C) is less than 1.

A ratio of a molar amount of the dicyandiamide (D) to a molar amount of epoxy groups of the epoxy resin (A) may be from 0.10 to 0.30.

The one-part curable resin composition further may contain 0.1 to 10 parts by weight of a curing accelerator (F) per 100 parts by weight of the epoxy resin (A).

Each of the core-shell-structured polymer particles may have a core layer containing at least one selected from the group consisting of diene rubber, (meth)acrylate rubber, and organosiloxane rubber.

The diene rubber may be butadiene rubber and/or butadiene-styrene rubber.

Each of the core-shell-structured polymer particles may have a core layer and a shell layer formed by graft polymerization of at least one monomer component to the core layer, the at least one monomer component being selected from the group consisting of an aromatic vinyl monomer, a vinyl cyanide monomer, and a (meth)acrylate monomer.

Each of the core-shell-structured polymer particles may have a shell layer having epoxy groups.

Each of the core-shell-structured polymer particles may have a core layer and a shell layer formed by graft polymerization of an epoxy group-containing monomer component to the core layer.

Each of the core-shell-structured polymer particles may have a shell layer having epoxy groups, and an amount of the epoxy groups of the shell layer is from 0.1 to 2.0 mmol/g based on a total amount of the shell layer.

One or more embodiments of the present invention also relate to a cured product resulting from curing of the one-part curable resin composition.

One or more embodiments of the present invention further relate to an adhesive containing the one-part curable resin composition. The adhesive may be a structural adhesive.

One or more embodiments of the present invention further relate to a laminate including: two substrates; and an adhesive layer resulting from curing of the adhesive, the adhesive layer joining the two substrates together.

One or more embodiments of the present invention further relate to a method for producing the cured product, the method including: mixing the epoxy resin (A), the core-shell-structured polymer particles and/or blocked urethane (B), the compound (C), and the dicyandiamide (D) to obtain a mixture; and heating the mixture to obtain the cured product.

One or more embodiments of the present invention can provide a one-part curable resin composition that contains an epoxy resin and dicyandiamide and that cures into a cured product that exhibits high impact peel performance.

### DETAILED DESCRIPTION OF THE EMBODIMENTS

Hereinafter, one or more embodiments of the present invention will be described. One or more embodiments of the present invention are not limited to the one or more embodiments described below.

One or more embodiments are directed to a one-part curable resin composition at least containing: an epoxy resin (A); core-shell-structured polymer particles and/or blocked urethane (B); a compound (C) having one to three phenolic hydroxy groups per molecule; and dicyandiamide (D).

<Epoxy Resin (A)>

The one-part curable resin composition of one or more embodiments contains the epoxy resin (A) as a curable resin. The epoxy resin used can be any of various epoxy resins. Examples of the epoxy resin include a bisphenol A epoxy resin, a bisphenol F epoxy resin, a bisphenol AD epoxy resin, a bisphenol S epoxy resin, a glycidyl ester epoxy resin, a glycidyl amine epoxy resin, a novolac epoxy resin, a bisphenol A propylene oxide adduct glycidyl ether epoxy resin, a hydrogenated bisphenol A (or F) epoxy resin, a fluorinated epoxy resin, a flame-retardant epoxy resin such as a glycidyl ether of tetrabromobisphenol A, a p-hydroxybenzoic acid glycidyl ether ester epoxy resin, an m-aminophenol epoxy resin, a diaminodiphenylmethane epoxy resin, various alicyclic epoxy resins, N,N-diglycidyl aniline, N,N-diglycidyl-o-toluidine, triglycidyl isocyanurate, divinylbenzene dioxide, resorcinol diglycidyl ether, a polyalkylene glycol diglycidyl ether, a glycol diglycidyl ether, a diglycidyl ester of an aliphatic polybasic acid, a glycidyl ether of an aliphatic polyhydric alcohol such as glycerin which has two or more hydroxy groups, a chelate-modified epoxy resin, a rubber-modified epoxy resin, a urethane-modified epoxy resin, a hydantoin epoxy resin, an epoxide of an unsaturated polymer such as a petroleum resin, an amino-containing glycidyl ether resin, and an epoxy compound derived from an addition reaction of a bisphenol A (or F) compound or a polybasic acid to any of the epoxy resins mentioned above. The epoxy resin used is not limited to those mentioned above and may be any commonly-used epoxy resin. One epoxy resin may be used alone, or two or more epoxy resins may be used in combination.

Specific examples of the polyalkylene glycol diglycidyl ether include polyethylene glycol diglycidyl ether and polypropylene glycol diglycidyl ether. Specific examples of the glycol diglycidyl ether include neopentyl glycol diglycidyl ether, 1,4-butanediol diglycidyl ether, 1,6-hexanediol diglycidyl ether, and cyclohexanedimethanol diglycidyl ether. Specific examples of the diglycidyl ester of an aliphatic polybasic acid include dimer acid diglycidyl ester, adipic acid diglycidyl ester, sebacic acid diglycidyl ester, and maleic acid diglycidyl ester. Specific examples of the glycidyl ether of an aliphatic polyhydric alcohol having two or more hydroxy groups include trimethylolpropane triglycidyl ether, trimethylolethane triglycidyl ether, castor oil-modified polyglycidyl ether, propoxylated glycerin triglycidyl ether, and sorbitol polyglycidyl ether. Examples of the epoxy compound derived from an addition reaction of a polybasic acid to an epoxy resin include a product of an addition reaction of tall oil fatty acid dimer (dimer acid) and a bisphenol A epoxy resin, and such an addition reaction product is described, for example, in WO 2010-098950.

The polyalkylene glycol diglycidyl ether, the glycol diglycidyl ether, the diglycidyl ester of an aliphatic polybasic acid, and the glycidyl ether of an aliphatic polyhydric alcohol having two or more hydroxy groups are epoxy resins having a relatively low viscosity. Such an epoxy resin, when used in combination with another epoxy resin such as a bisphenol A epoxy resin or bisphenol F epoxy resin, functions as a reactive diluent, which can improve the balance between the viscosity of the resulting composition and the physical properties of the cured product of the composition. The amount of such an epoxy resin functioning as a reactive diluent may be from 0.5 to 20 wt %, from 1 to 10 wt %, or from 2 to 5 wt % in the component (A).

The chelate-modified epoxy resin is a reaction product of an epoxy resin and a chelate functional group-containing compound (chelate ligand). When a one-part curable resin composition containing such a chelate-modified epoxy resin is used as an adhesive for vehicles, bond performance to the surface of a metal substrate contaminated by an oily substance can be improved. The chelate functional group is a functional group of a compound having in the molecule a plurality of coordination positions capable of coordination with metal ions, and examples of the chelate functional group include phosphorus-containing acid groups (such as —PO(OH)₂), carboxylic acid groups (—CO₂H), sulfur-containing acid groups (such as —SO₃H), amino groups, and hydroxy groups (in particular, adjacent hydroxy groups on an aromatic ring). Examples of the chelate ligand include ethylenediamine, bipyridine, ethylenediaminetetraacetic acid, phenanthroline, porphyrin, and crown ether. Commercially-available examples of the chelate-modified epoxy resin include ADEKA RESIN EP-49-10N manufactured by ADEKA Corporation. The amount of the chelate-modified epoxy resin used in the component (A) may be from 0.1 to 10 wt % or from 0.5 to 3 wt %.

The rubber-modified epoxy resin may be a reaction product derived from a reaction of rubber and an epoxy group-containing compound and having 1.1 or more epoxy groups, or two or more epoxy groups, on average per molecule. Examples of the rubber include rubber polymers such as acrylonitrile-butadiene rubber (NBR), styrene-butadiene rubber (SBR), hydrogenated nitrile rubber (HNBR), ethylene propylene rubber (EPDM), acrylic rubber (ACM), butyl rubber (IIR), butadiene rubber, and polyoxyalkylenes such as polypropylene oxide, polyethylene oxide, and polytetramethylene oxide. The rubber polymer used may be one that is terminated by reactive groups such as amino, hydroxy, or carboxyl groups. A product formed by reacting a rubber polymer and an epoxy resin by a known method in any suitable proportions is a rubber-modified epoxy resin. Among such rubber-modified epoxy resins, acrylonitrile-butadiene rubber-modified epoxy resins and polyoxyalkylene-modified epoxy resins are preferred in terms of the bond performance and impact peel performance of the resulting one-part curable resin composition, and acrylonitrile-butadiene rubber-modified epoxy resins are more preferred. An acrylonitrile-butadiene rubber-modified epoxy resin can be obtained, for example, by a reaction of carboxyl-terminated NBR (CTBN) and a bisphenol A epoxy resin.

The amount of the acrylonitrile monomer component in the acrylonitrile-butadiene rubber may be from 5 to 40 wt %, from 10 to 35 wt %, or from 15 to 30 wt % in terms of the bond performance and impact peel performance of the resulting one-part curable resin composition. In terms of the workability of the resulting one-part curable resin composition, the amount of the acrylonitrile monomer component may be from 20 to 30 wt %.

For example, a product resulting from an addition reaction between an amino-terminated polyoxyalkylene and an epoxy resin (this reaction product will be also referred to as “adduct” hereinafter) is also classified as a rubber-modified epoxy resin. The adduct can be easily produced by a known method as described, for example, in U.S. Pat. No. 5,084,532 or in U.S. Pat. No. 6,015,865. Examples of the epoxy resin used to produce the adduct include the above-mentioned specific examples of the component (A). A bisphenol A epoxy resin and a bisphenol F epoxy resin are preferred, and a bisphenol A epoxy resin is more preferred. Commercially-available examples of the amino-terminated polyoxyalkylene used to produce the adduct include Jeffamine D-230, Jeffamine D-400, Jeffamine D-2000, Jeffamine D-4000, and Jeffamine T-5000 manufactured by Huntsman.

The average number of epoxy-reactive terminal groups per molecule in the rubber may be from 1.5 to 2.5 or from 1.8 to 2.2. The number-average molecular weight of the rubber, as measured as a polystyrene-equivalent molecular weight by GPC, may be from 1000 to 10000, from 2000 to 8000, or from 3000 to 6000.

The method for producing the rubber-modified epoxy resin is not limited to a particular technique. For example, the rubber-modified epoxy resin can be produced by reacting rubber and a large amount of epoxy group-containing compound. Specifically, it is preferable to produce the rubber-modified epoxy resin by reacting two or more equivalents of the epoxy group-containing compound per equivalent of epoxy-reactive terminal groups of the rubber. The amount of the epoxy group-containing compound used in the reaction may be large enough so that the resulting product will be a mixture of the epoxy group-containing compound present in a free form and an adduct of the rubber and the epoxy group-containing compound. For example, the rubber-modified epoxy resin is produced by heating up to a temperature of 100 to 250° C. in the presence of a catalyst such as phenyl dimethyl urea or triphenylphosphine. The epoxy group-containing compound used to produce the rubber-modified epoxy resin is not limited to a particular compound, but may be a bisphenol A epoxy resin or a bisphenol F epoxy resin or a bisphenol A epoxy resin. In the case where an excess amount of epoxy group-containing compound is used for rubber-modified epoxy resin production, the unreacted epoxy group-containing compound remaining after the reaction is not classified as a rubber-modified epoxy resin as defined herein.

The properties of the rubber-modified epoxy resin can be modified through a preliminary reaction with a bisphenol component. The amount of the bisphenol component used for property modification may be from 3 to 35 parts by weight or from 5 to 25 parts by weight per 100 parts by weight of the rubber component in the rubber-modified epoxy resin. A cured product resulting from curing of a one-part curable resin composition containing the rubber-modified epoxy resin with modified properties excels in bond retention after exposure to high temperature and excels also in impact resistance at low temperature.

The glass transition temperature (Tg) of the rubber-modified epoxy resin is not limited to a particular range, but may be −25° C. or lower, −35° C. or lower, −40° C. or lower, or −50° C. or lower.

The number-average molecular weight of the rubber-modified epoxy resin, as measured as a polystyrene-equivalent molecular weight by GPC, may be from 1500 to 40000, from 3000 to 30000, or from 4000 to 20000. The dispersity (the ratio of the weight-average molecular weight to the number-average molecular weight) may be from 1 to 4, from 1.2 to 3, or from 1.5 to 2.5.

One rubber-modified epoxy resin may be used alone, or two or more rubber-modified epoxy resins may be used in combination.

The amount of the rubber-modified epoxy resin used in the component (A) may be from 1 to 50 wt %, from 2 to 40 wt %, from 5 to 30 wt %, or from 10 to 20 wt %.

The urethane-modified epoxy resin is a reaction product that is derived from a reaction between an epoxy group-containing compound having a group reactive with an isocyanate group and an isocyanate group-containing urethane prepolymer and that may have 1.1 or more epoxy groups, or 2 or more epoxy groups, on average per molecule. For example, the urethane-modified epoxy resin can be obtained by reacting a hydroxy group-containing epoxy compound and a urethane prepolymer.

The number-average molecular weight of the urethane-modified epoxy resin, as measured as a polystyrene-equivalent molecular weight by GPC, may be from 1500 to 40000, from 3000 to 30000, or from 4000 to 20000. The dispersity (the ratio of the weight-average molecular weight to the number-average molecular weight) may be from 1 to 4, from 1.2 to 3, or from 1.5 to 2.5.

One urethane-modified epoxy resin may be used alone, or two or more urethane-modified epoxy resins may be used in combination.

The amount of the urethane-modified epoxy resin used in the component (A) may be from 1 to 50 wt %, from 2 to 40 wt %, from 5 to 30 wt %, or from 10 to 20 wt %.

Among the epoxy resins mentioned above, an epoxy resin having at least two epoxy groups per molecule is preferred in that such an epoxy resin is highly curable and exhibits high flexibility after curing and in that blending it with the core-shell polymer particles (B) provides a significant enhancing effect on impact peel performance. A compound having two epoxy groups per molecule is particularly preferred.

Among the epoxy resins mentioned above, a bisphenol A epoxy resin or a bisphenol F epoxy resin is preferred since the resulting cured product has high elastic modulus and excels in heat resistance and bond performance and since these resins are relatively inexpensive. A bisphenol A epoxy resin is particularly preferred.

Among the various epoxy resins, an epoxy resin having an epoxy equivalent weight of less than 220 is preferred since the resulting cured product has high elastic modulus and high heat resistance. The epoxy equivalent weight may be from 90 to less than 210 or from 150 to less than 200.

A bisphenol A epoxy resin or bisphenol F epoxy resin having an epoxy equivalent weight of less than 220 is particularly preferred since these resins are liquid at room temperature and since the resulting one-part curable resin composition is easy to handle.

A bisphenol A epoxy resin or bisphenol F epoxy resin having an epoxy equivalent weight of 220 to less than 5000 may be added in an amount of 40 wt % or less, or 20 wt % or less, in the component (A), since in this case the resulting cured product excels in impact resistance.

<Core-Shell Polymer Particles and/or Blocked Urethane (B)>

The one-part curable resin composition of one or more embodiments contains core-shell-structured polymer particles and/or blocked urethane as the component (B). Thanks to the toughness enhancing effect of the component (B), the resulting cured product excels in impact peel performance. The use of the component (B) and the component (C) described later in combination with the components (A) and (D) can provide a synergistic effect that significantly improves the impact peel performance of the cured product obtained from the one-part curable resin composition. Only either the core-shell-structured polymer particles or the blocked urethane may be contained as the component (B). Both the core-shell-structured polymer particles and the blocked urethane may be contained. It is preferable that at least the core-shell-structured polymer particles be contained as the component (B). Hereinafter, the core-shell-structured polymer particles will also be referred to as core-shell polymer particles.

<Core-Shell Polymer Particles>

Each of the core-shell polymer particles (B) may have a shell layer having no epoxy groups but may have a shell layer having epoxy groups. In terms of the impact peel performance of the resulting cured product, the amount of the epoxy groups of the shell layer of each of the core-shell polymer particles (B) may be from 0.1 to 2.0 mmol/g or from 0.3 to 1.5 mmol/g based on the total amount of the shell layer. In this case, it is expected that aggregation of the core-shell polymer particles (B) can be prevented to allow the core-shell polymer particles (B) to be dispersed as primary particles in the cured product and that in consequence the impact peel performance of the cured product can be improved.

The particle size of the core-shell polymer particles (B) is not limited to a particular range. In view of industrial productivity, the volume mean diameter (Mv) of the core-shell polymer particles (B) may be from 10 to 2000 nm, from 30 to 600 nm, from 50 to 400 nm, or from 100 to 300 nm. The volume mean diameter (Mv) of the polymer particles can be measured for a latex of the polymer particles using Microtrac UPA150 (manufactured by Nikkiso Co., Ltd.).

The core-shell polymer particles (B) in the one-part curable resin composition may have a number-weighted particle size distribution with a full width at half maximum that is from 0.5 to 1 times the volume mean diameter, since in this case the resulting one-part curable resin composition has a low viscosity and is easy to handle.

In terms of easily achieving the particular particle size distribution described above, the number-weighted particle size distribution of the core-shell polymer particles (B) may have two or more local maxima. In terms of effort and cost required for production, the number-weighted particle size distribution may have two to three local maxima and may have two local maxima. In particular, the core-shell polymer particles (B) may include 10 to 90 wt % of core-shell polymer particles having a volume mean diameter of 10 to less than 150 nm or 90 to 10 wt % of core-shell polymer particles having a volume mean diameter of 150 to 2000 nm.

The core-shell polymer particles (B) may be dispersed as primary particles in the one-part curable resin composition. As used herein, the statement that “core-shell polymer particles are dispersed as primary particles” (this dispersion state will be also referred to as “primary dispersion state” hereinafter) means that the core-shell polymer particles are dispersed substantially independent of (without being in contact with) one another. Whether the particles are in this dispersion state can be confirmed, for example, by dissolving a part of the one-part curable resin composition in a solvent such as methyl ethyl ketone and subjecting the solution to particle size analysis using a device such as a laser scattering particle size analyzer.

The value of volume mean diameter (Mv)/number mean diameter (Mn) as determined by the particle size analysis is not limited to a particular range, but may be 3 or less, 2.5 or less, 2 or less, or 1.5 or less. When the value of volume mean diameter (Mv)/number mean diameter (Mn) is 3 or less, the core-shell polymer particles (B) are considered to be dispersed well, and the resulting cured product has good physical properties such as high impact resistance and high bond performance.

The value of volume mean diameter (Mv)/number mean diameter (Mn) can be determined by measuring the Mv and Mn using Microtrac UPA (manufactured by Nikkiso Co., Ltd.) and dividing the Mv by the Mn.

“Stable dispersion” of the core-shell polymer particles means that the core-shell polymer particles remain dispersed steadily under normal conditions for a long period of time without being aggregated, separated, or precipitated in the continuous phase. The distribution of the core-shell polymer particles in the continuous phase may remain substantially unchanged. The state of “stable dispersion” may be maintained even when the viscosity of the composition containing the core-shell polymer particles and the continuous phase is reduced by heating the composition to the extent that there is no danger and the composition with the reduced viscosity is stirred.

One type of core-shell polymer particles (B) may be used alone, or two or more types of core-shell polymer particles (B) may be used in combination.

The core-shell polymer particles (B) are not limited to a particular structure, but each of the core-shell polymer particles (B) may include two or more layers. Each of the core-shell polymer particles (B) may have a structure formed of three or more layers including a core layer, an intermediate layer covering the core layer, and a shell layer covering the intermediate layer.

Hereinafter, the layers of the core-shell polymer particles (B) will be described in detail.

<<Core Layer>>

In order to enhance the toughness of the cured product of the one-part curable resin composition, the core layer may be an elastic core layer having rubbery properties. For the elastic core layer to have rubbery properties, the gel content of the elastic core layer may be 60 wt % or more, 80 wt % or more, 90 wt % or more, or 95 wt % or more. The term “gel content” as used herein refers to a parameter determined as follows: 0.5 g of crumb obtained through coagulation and drying is immersed in 100 g of toluene and allowed to stand at 23° C. for 24 hours, then insoluble matter and soluble matter are separated from each other, and the percentage of the insoluble matter to the total amount of the insoluble matter and the soluble matter is determined as the gel content.

The core layer may contain at least one selected from the group consisting of diene rubber, (meth)acrylate rubber, and organosiloxane rubber. The core layer contains diene rubber in terms of increasing the enhancing effect on the impact peel performance of the resulting cured product and in terms of ensuring a low affinity for the epoxy resin (A) to reduce the likelihood of a viscosity increase over time due to the core layer being swelled with the component (A).

(Diene Rubber)

Examples of a conjugated diene monomer for forming the diene rubber include 1,3-butadiene, isoprene, 2-chloro-1,3-butadiene, and 2-methyl-1,3-butadiene. One of these conjugated diene monomers may be used alone, or two or more thereof may be used in combination.

The amount of the conjugated diene monomer may be from 50 to 100 wt %, from 70 to 100 wt %, or from 90 to 100 wt %, of the core layer. When the amount of the conjugated diene monomer is 50 wt % or more, the impact peel performance of the resulting cured product can be further improved.

Examples of a vinyl monomer copolymerizable with the conjugated diene monomer include: vinylarenes such as styrene, α-methylstyrene, monochlorostyrene, and dichlorostyrene; vinyl carboxylic acids such as acrylic acid and methacrylic acid; vinyl cyanides such as acrylonitrile and methacrylonitrile; vinyl halides such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinylbenzene. One of these vinyl monomers may be used alone, or two or more thereof may be used in combination. Styrene is particularly preferred.

The amount of the vinyl monomer copolymerizable with the conjugated diene monomer may be from 0 to 50 wt %, from 0 to 30 wt %, or from 0 to 10 wt %, of the core layer. When the amount of the vinyl monomer copolymerizable with the conjugated diene monomer is 50 wt % or less, the impact peel performance of the resulting cured product can be further improved.

In terms of increasing the enhancing effect on the impact peel performance and in terms of ensuring a low affinity for the epoxy resin (A) to reduce the likelihood of a viscosity increase over time due to the core layer being swelled with the component (A), the diene rubber may be butadiene rubber made with 1,3-butadiene and/or butadiene-styrene rubber which is a copolymer of 1,3-butadiene and styrene. Butadiene rubber is more preferred. Butadiene-styrene rubber is preferred in that the use of this rubber allows for refractive index adjustment leading to increased transparency of the resulting cured product.

((Meth)acrylate Rubber)

The (meth)acrylate rubber may be a rubber elastic material obtained by polymerization of a monomer mixture containing 50 to 100 wt % of at least one monomer selected from the group consisting of (meth)acrylate monomers and 0 to 50 wt % of another vinyl monomer copolymerizable with the at least one (meth)acrylate monomer.

Examples of the (meth)acrylate monomer include: (i) alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; (ii) aromatic ring-containing (meth)acrylates such as phenoxyethyl (meth)acrylate and benzyl (meth)acrylate; (iii) hydroxyalkyl (meth)acrylates such as 2-hydroxyethyl (meth)acrylate and 4-hydroxybutyl (meth)acrylate; (iv) glycidyl (meth)acrylates such as glycidyl (meth)acrylate and glycidyl alkyl (meth)acrylate; (v) alkoxyalkyl (meth)acrylates; (vi) allylalkyl (meth)acrylates such as allyl (meth)acrylate and allylalkyl (meth)acrylate; and (vii) polyfunctional (meth)acrylates such as monoethylene glycol di(meth)acrylate, triethylene glycol di(meth)acrylate, and tetraethylene glycol di(meth)acrylate. One of these (meth)acrylate monomers may be used alone, or two or more thereof may be used in combination. Ethyl (meth)acrylate, butyl (meth)acrylate, and 2-ethylhexyl (meth)acrylate are preferred as the (meth)acrylate monomer.

Examples of the other vinyl monomer copolymerizable with the (meth)acrylate monomer include: (i) vinylarenes such as styrene, α-methylstyrene, monochlorostyrene, and dichlorostyrene; (ii) vinyl carboxylic acids such as acrylic acid and methacrylic acid; (iii) vinyl cyanides such as acrylonitrile and methacrylonitrile; (iv) vinyl halides such as vinyl chloride, vinyl bromide, and chloroprene; (v) vinyl acetate; (vi) alkenes such as ethylene, propylene, butylene, and isobutylene; and (vii) polyfunctional monomers such as diallyl phthalate, triallyl cyanurate, triallyl isocyanurate, and divinylbenzene. One of these vinyl monomers may be used alone, or two or more thereof may be used in combination. Styrene is particularly preferred in that the use of styrene can easily increase the refractive index.

(Organosiloxane Rubber)

Examples of the organosiloxane rubber include: (i) polysiloxane polymers composed of alkyl- or aryl-disubstituted silyloxy units such as dimethylsilyloxy, diethylsilyloxy, methylphenylsilyloxy, diphenylsilyloxy, or dimethylsilyloxy-diphenylsilyloxy units; and (ii) polysiloxane polymers composed of alkyl- or aryl-monosubstituted silyloxy units such as organohydrogen silyloxy units in which some side-chain alkyl groups are substituted by hydrogen atoms. One of these polysiloxane polymers may be used alone, or two or more thereof may be used in combination. Among the polysiloxane polymers, a polysiloxane polymer composed of dimethylsilyloxy, methylphenylsilyloxy, or dimethylsilyloxy-diphenylsilyloxy units is preferred since such a polysiloxane polymer can provide heat resistance to the cured product. A polysiloxane polymer composed of dimethylsilyloxy units is most preferred since such a polysiloxane polymer is easily available. In the case where the core layer is made of the organosiloxane rubber, the polysiloxane polymer portion may be contained in an amount of 80 wt % or more (or 90 wt % or more) based on 100 wt % of the total amount of the organosiloxane rubber in order not to reduce the heat resistance of the cured product.

The glass transition temperature (also simply referred to as “Tg” hereinafter) of the core layer may be 0° C. or lower, −20° C. or lower, −40° C. or lower, or −60° C. or lower in order to enhance the toughness of the resulting cured product.

The volume mean diameter of the core layers may be from 0.03 to 2 μm and from 0.05 to 1 μm. When the volume mean diameter is in this range, the core layers can be stably produced, and the cured product can have high heat resistance and high impact resistance. The volume mean diameter can be measured using Microtrac UPA150 (manufactured by Nikkiso Co., Ltd.).

The proportion of the core layers in the core-shell polymer particles may be from 40 to 97 wt %, from 60 to 95 wt %, from 70 to 93 wt %, and from 80 to 90 wt % based on 100 wt % of the total weight of the core-shell polymer particles. When the proportion of the core layers is 40 wt % or more, the impact peel performance of the resulting cured product can be further improved. When the proportion of the core layers is 97 wt % or less, the core-shell polymer particles are resistant to aggregation, and the one-part curable resin composition can have a lower viscosity and better workability.

In many cases, the core layer has a single-layer structure. The core layer may have a multilayer structure formed of layers having rubber elasticity. When the core layer has a multilayer structure, the layers forming the core layer may have different polymer compositions as long as the polymer compositions are within the scope of the foregoing disclosure.

<<Intermediate Layer>>

An intermediate layer may be formed between the core layer and the shell layer if necessary. In particular, a rubber surface-crosslinked layer as described below may be formed as the intermediate layer. In terms of the enhancing effect on the toughness and impact peel performance of the resulting cured product, it is preferable for the polymer particles not to have any intermediate layer, in particular the rubber surface-crosslinked layer as described below.

In the case where there is an intermediate layer, the proportion of the intermediate layer may be from 0.1 to 30 parts by weight, from 0.2 to 20 parts by weight, from 0.5 to 10 parts by weight, or from 1 to 5 parts by weight per 100 parts by weight of the core layer.

The rubber surface-crosslinked layer is made of an intermediate layer polymer formed by polymerization of a rubber surface-crosslinked layer component containing 30 to 100 wt % of a polyfunctional monomer having two or more radical-polymerizable double bonds per molecule and 0 to 70 wt % of another vinyl monomer. The rubber surface-crosslinked layer has the effect of reducing the viscosity of the one-part curable resin composition and the effect of improving the dispersibility of the core-shell polymer particles (B) in the component (A). The rubber surface-crosslinked layer further has the effect of increasing the crosslink density of the core layer and enhancing the graft efficiency of the shell layer.

The polyfunctional monomer is other than conjugated diene monomers such as butadiene, and specific examples of the polyfunctional monomer include: allylalkyl (meth)acrylates such as allyl (meth)acrylate and allylalkyl (meth)acrylate; allyloxyalkyl (meth)acrylates; polyfunctional (meth)acrylates having two or more (meth)acrylic groups, such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; and other polyfunctional monomers such as diallyl phthalate, triallyl cyanurate, triallyl isocyanurate, and divinylbenzene. Allyl methacrylate and triallyl isocyanurate are preferred. The term “(meth)acrylate” as used herein means acrylate and/or methacrylate.

<<Shell Layer>>

The shell layer, which is the outermost layer of each of the core-shell polymer particles, is a product of polymerization of a monomer for shell layer formation. The shell layer is made of a shell polymer that serves to increase the compatibility between the core-shell polymer particles (B) and the component (A) and allow the core-shell polymer particles (B) to be dispersed as primary particles in the one-part curable resin composition or the cured product of the composition.

Such a shell polymer may be grafted to the core layer and/or the intermediate layer. Hereinafter, the phrase “grafted to the core layer” is intended to include the case where the shell polymer is grafted to the intermediate layer formed on the core layer. To be precise, it is preferable that a monomer component used for shell layer formation be graft-polymerized to a core polymer forming the core layer (in the case where the intermediate layer is formed, the core polymer includes an intermediate layer polymer forming the intermediate layer; the same applies to the following description) and that the shell polymer and the core polymer be chemically bonded substantially (in the case where the intermediate layer is formed, it is preferable for the shell polymer and the intermediate layer polymer to be chemically bonded). That is, the shell polymer may be formed by graft-polymerizing the monomer for shell layer formation in the presence of the core polymer, thus being graft-polymerized to the core polymer and covering a part or the whole of the core polymer. This polymerization process can be carried out by preparing a latex of the core polymer in the form of a water-based polymer latex and by adding and polymerizing the monomer for shell polymer formation in the latex of the core polymer.

In terms of the compatibility and dispersibility of the core-shell polymer particles (B) in the one-part curable resin composition, the monomer for shell layer formation may be, for example, an aromatic vinyl monomer, a vinyl cyanide monomer, or a (meth)acrylate monomer and a (meth)acrylate monomer. In particular, the monomer for shell layer formation may include methyl methacrylate. One of the mentioned monomers for shell layer formation may be used alone, or two or more thereof may be used in any suitable combination.

The total amount of the aromatic vinyl monomer, the vinyl cyanide monomer, and the (meth)acrylate monomer may be from 10 to 99.5 wt %, from 50 to 99 wt %, from 65 to 98 wt %, from 67 to 90 wt %, or from 67 to 85 wt % based on 100 wt % of the monomer for shell layer formation.

The amount of methyl methacrylate may be from 5 to 100 wt %, from 20 to 99 wt %, from 30 to 97 wt %, or from 70 to 95 wt % based on 100 wt % of the monomer for shell layer formation.

In terms of chemically bonding the core-shell polymer particles (B) to the component (A) to allow the core-shell polymer particles (B) to maintain a good dispersion state without aggregation in the cured product or the one-part curable resin composition, the monomer for shell layer formation may include a reactive group-containing monomer containing at least one selected from the group consisting of an epoxy group, an oxetane group, a hydroxy group, an amino group, an imide group, a carboxylic acid group, a carboxylic anhydride group, a cyclic ester, a cyclic amide, a benzoxazine group, and a cyanic ester group. A monomer having an epoxy group is particularly preferred.

In terms of impact peel performance and storage stability, the monomer having an epoxy group may be contained in an amount of 0 to 90 wt %, 1 to 50 wt %, 2 to 35 wt %, or 3 to 20 wt %, based on 100 wt % of the monomer for shell layer formation.

The monomer having an epoxy group may be used for shell layer formation or used only for shell layer formation.

It is preferable to use a polyfunctional monomer having two or more radical-polymerizable double bonds as the monomer for shell layer formation since the use of such a polyfunctional polymer can prevent swelling of the core-shell polymer particles in the one-part curable resin composition, and tends to allow the one-part curable resin composition to have a low viscosity and good handleability. In terms of the enhancing effect on the toughness and impact peel performance of the resulting cured product, it is preferable not to use the polyfunctional monomer having two or more radical-polymerizable double bonds as the monomer for shell layer formation.

The polyfunctional monomer may be contained, for example, in an amount of 0 to 20 wt % based on 100 wt % of the monomer for shell layer formation and may be contained in an amount of 1 to 20 wt %, or 5 to 15 wt %, based on 100 wt % of the monomer for shell layer formation.

Specific examples of the aromatic vinyl monomer include vinylbenzenes such as styrene, α-methylstyrene, p-methylstyrene, and divinylbenzene.

Specific examples of the vinyl cyanide monomer include acrylonitrile and methacrylonitrile.

Specific examples of the (meth)acrylate monomer include: alkyl (meth)acrylates such as methyl (meth)acrylate, ethyl (meth)acrylate, and butyl (meth)acrylate; and hydroxyalkyl (meth)acrylates.

Specific examples of the hydroxyalkyl (meth)acrylates include: linear hydroxyalkyl (meth)acrylates (in particular, C1-C6 linear hydroxyalkyl (meth)acrylates) such as 2-hydroxyethyl (meth)acrylate, hydroxypropyl (meth)acrylate, and 4-hydroxybutyl (meth)acrylate; caprolactone-modified hydroxy(meth)acrylate; branched hydroxyalkyl (meth)acrylates such as methyl α-(hydroxymethyl)acrylate and ethyl α-(hydroxymethyl)acrylate; and hydroxy group-containing (meth)acrylates such as mono(meth)acrylate of a polyester diol (in particular, a saturated polyester diol) obtained from a dicarboxylic acid (such as phthalic acid) and a diol (such as propylene glycol).

Specific examples of the monomer having an epoxy group include glycidyl group-containing vinyl monomers such as glycidyl (meth)acrylate, 4-hydroxybutyl (meth)acrylate glycidyl ether, and allyl glycidyl ether.

Specific examples of the polyfunctional monomer having two or more radical-polymerizable double bonds include the monomers mentioned as examples of the previously-described polyfunctional monomer. Allyl methacrylate and triallyl isocyanurate are preferred.

In one or more embodiments, the shell layer may be formed as a polymer of a monomer for shell layer formation (the total amount of the monomer is 100 wt %) that contains, for example, 0 to 50 wt % (1 to 50 wt %, or 2 to 48 wt %) of an aromatic vinyl monomer (in particular, styrene), 0 to 50 wt % (0 to 30 wt %, or 10 to 25 wt %) of a vinyl cyanide monomer (in particular, acrylonitrile), 0 to 100 wt % (5 to 100 wt %, or 70 to 95 wt %) of a (meth)acrylate monomer (in particular, methyl methacrylate), and 1 to 50 wt % (2 to 35 wt %, or 3 to 20 wt %) of a monomer having an epoxy group (in particular, glycidyl methacrylate). In this case, desired toughness enhancing effect and desired mechanical properties can be achieved in a balanced manner.

One of the above monomer components may be used alone, or two or more thereof may be used in combination. The shell layer may be formed using another monomer component in addition to any of the above monomer components.

The graft ratio of the shell layer may be 70% or more (80% or more or 90% or more). When the graft ratio is 70% or more, the one-part curable resin composition can have a lower viscosity.

The method for calculating the graft ratio is as follows. First, a water-based latex containing the core-shell polymer particles is coagulated and dehydrated, and finally the dehydrated product is dried to give a powder consisting of the core-shell polymer particles. After that, 2 g of the powder consisting of the core-shell polymer particles is immersed in 100 g of methyl ethyl ketone (MEK) at 23° C. for 24 hours, after which MEK-soluble matter is separated from MEK-insoluble matter, and then methanol-insoluble matter is separated from the MEK-soluble matter. The graft ratio is calculated by determining the percentage of the MEK-insoluble matter to the total amount of the MEK-insoluble matter and the methanol-insoluble matter.

<<Method for Producing Core-Shell Polymer Particles>>

(Method for Producing Core Layers)

The core layers of the core-shell polymer particles (B) can be produced, for example, by emulsion polymerization, suspension polymerization, or microsuspension polymerization. For example, a method as described in WO 2005/028546 can be used.

(Methods for Forming Shell Layers and Intermediate Layers)

The intermediate layers can be formed by polymerizing a monomer for intermediate layer formation using a known radical polymerization process. In the case where a rubber elastic material forming the core layers is obtained in the form of an emulsion, the polymerization of the monomer for intermediate layer formation may be carried out by emulsion polymerization.

The shell layers can be formed by polymerizing a monomer for shell layer formation using a known radical polymerization process. In the case where the core layers or polymer particle precursors consisting of the core layers covered by the intermediate layers are obtained in the form of an emulsion, the polymerization of the monomer for shell layer formation may be carried out by emulsion polymerization. For example, the shell layers can be produced according to the method described in WO 2005/028546.

Examples of an emulsifier (dispersant) that can be used in emulsion polymerization include anionic emulsifiers (dispersants), including: various acids such as alkyl or aryl sulfonic acids as exemplified by dioctyl sulfosuccinic acid and dodecylbenzenesulfonic acid, alkyl ether or aryl ether sulfonic acids, alkyl or aryl sulfuric acids as exemplified by dodecyl sulfuric acid, alkyl ether or aryl ether sulfuric acids, alkyl- or aryl-substituted phosphoric acids, alkyl ether- or aryl ether-substituted phosphoric acids, N-alkyl or aryl sarcosine acids as exemplified by dodecyl sarcosine acid, alkyl or aryl carboxylic acids as exemplified by oleic acid and stearic acid, and alkyl ether or aryl ether carboxylic acids; and alkali metal salts or ammonium salts of the mentioned acids. Other examples include: non-ionic emulsifiers (dispersants) such as alkyl- or aryl-substituted polyethylene glycol; and dispersants such as polyvinyl alcohol, alkyl-substituted cellulose, polyvinylpyrrolidone, and polyacrylic acid derivatives. One of these emulsifiers (dispersants) may be used alone, or two or more thereof may be used in combination.

The amount of the emulsifier (dispersant) used may be minimized to the extent that the dispersion stability of a water-based latex of the polymer particles is not affected. The emulsifier (dispersant) may have high water solubility. When the emulsifier (dispersant) has high water solubility, the emulsifier (dispersant) can be easily removed by washing with water and easily prevented from causing an adverse effect on the resulting cured product.

In the case of employing emulsion polymerization, a known initiator such as 2,2′-azobisisobutyronitrile, hydrogen peroxide, potassium persulfate, or ammonium persulfate can be used as a thermally-decomposable initiator.

A redox initiator may be used, and examples of the redox initiator include organic peroxides such as t-butylperoxyisopropyl carbonate, p-menthane hydroperoxide, cumene hydroperoxide, dicumyl peroxide, t-butyl hydroperoxide, di-t-butyl peroxide, and t-hexyl peroxide. The redox initiator may be one that contains an inorganic peroxide such as hydrogen peroxide, potassium persulfate, or ammonium persulfate optionally combined with a reductant such as sodium formaldehyde sulfoxylate or glucose, a transition metal salt such as iron(II) sulfate, a chelate agent such as disodium ethylenediaminetetraacetate, and a phosphorus-containing compound such as sodium pyrophosphate.

The use of a redox initiator system is preferred since in this case the polymerization can be carried out at a low temperature at which the peroxide undergoes substantially no thermal decomposition and the polymerization temperature can be set over a wide range. In particular, an organic peroxide such as cumene hydroperoxide, dicumyl peroxide, or t-butyl hydroperoxide may be used as the redox initiator. The amount of the initiator used may be as known in the art. In the case of using the redox initiator, the amounts of the reductant, the transition metal salt, and the chelate agent may be as known in the art. In the case of polymerization of a monomer having two or more radical-polymerizable double bonds, a known chain transfer agent can be used in an amount as known in the art. A surfactant can be additionally used, and the amount of the surfactant may be as known in the art.

The polymerization conditions such as polymerization temperature, pressure, and deoxygenation may be as known in the art. The polymerization of the monomer for intermediate layer formation may be carried out in a single stage or two or more stages. For example, one method is to add the monomer for intermediate layer formation, at one time or continuously, to an emulsion of a rubber elastic material forming the elastic core layers. Another exemplary method is to add an emulsion of a rubber elastic material forming the elastic core layers to a reactor charged with the monomer for intermediate layer formation and then carry out polymerization.

In the case where the core-shell polymer particles are used as the component (B), the amount of the core-shell polymer particles may be from 1 to 100 parts by weight, from 2 to 80 parts by weight, from 3 to 60 parts by weight, from 4 to 50 parts by weight, or from 5 to 40 parts by weight per 100 parts by weight of the epoxy resin (A) in terms of the balance between the handleability of the resulting one-part curable resin composition and the toughness enhancing effect on the resulting cured product.

<Blocked Urethane>

Blocked urethane, which is one form of the component (B), is a compound derived from an elastomer compound containing urethane and/or urea groups and terminated by isocyanate groups, and is obtained by capping part or all of the terminal isocyanate groups of the elastomer compound with any of various blocking agents having active hydrogen groups. In particular, a compound is preferred in which all of the terminal isocyanate groups are capped with a blocking agent. Such a compound can be obtained, for example, as follows: an organic polymer terminated by active hydrogen-containing groups is reacted with an excess of polyisocyanate compound to give a polymer (urethane prepolymer) having urethane and/or urea groups in the main chain and terminated by isocyanate groups and, subsequently or simultaneously, all or part of the isocyanate groups are capped with a blocking agent having active hydrogen groups.

The blocked urethane is represented, for example, by the following formula (1):

A-(NR²—C(═O)—X)ₐ (1), wherein

R² groups, the number of which is a, are each independently a hydrocarbon group having 1 to 20 carbon atoms, a is the average number of capped isocyanate groups per molecule and may be 1.1 or more, from 1.5 to 8, from 1.7 to 6, or from 2 to 4, X is a residue of the blocking agent from which the active hydrogen atoms have been removed, and A is a residue of the urethane prepolymer from which the terminal isocyanate groups have been removed.

The number-average molecular weight of the blocked urethane, as measured as a polystyrene-equivalent molecular weight by GPC, may be from 2000 to 40000, from 3000 to 30000, or from 4000 to 20000. The dispersity (the ratio of the weight-average molecular weight to the number-average molecular weight) may be from 1 to 4, from 1.2 to 3, or from 1.5 to 2.5.

(Organic Polymer Terminated by Active Hydrogen-Containing Groups)

Examples of the backbone of the organic polymer terminated by active hydrogen-containing groups include a polyether polymer, a polyacrylic polymer, a polyester polymer, a polydiene polymer, a saturated hydrocarbon polymer (polyolefin), and a polythioether polymer.

(Active Hydrogen-Containing Groups)

Examples of the active hydrogen-containing groups of the active hydrogen-containing group-terminated organic polymer include hydroxy, amino, imino, and thiol groups. Among these, hydroxy, amino, and imino groups are preferred in terms of availability. Hydroxy groups are more preferred in terms of the handleability (viscosity) of the resulting blocked urethane.

Examples of the active hydrogen-containing group-terminated organic polymer include a polyether polymer terminated by hydroxy groups (polyether polyol), a polyether polymer terminated by amino- and/or imino groups (polyetheramine), a polyacrylic polyol, a polyester polyol, a diene polymer terminated by hydroxy groups (polydiene polyol), a saturated hydrocarbon polymer terminated by hydroxy groups (polyolefin polyol), a polythiol compound, and a polyamine compound. Among these, the polyether polyol, the polyetheramine, and the polyacrylic polyol are preferred since these organic polymers have high compatibility with the component (A) and have a relatively low glass transition temperature and since the use of any of these organic polymers allows the resulting cured product to have high impact resistance at low temperature. In particular, the polyether polyol and the polyetheramine are more preferred since the use of either of these polymers allows the resulting organic polymer to have a low viscosity and high workability. The polyether polyol is particularly preferred.

In preparation of the urethane prepolymer which is a precursor of the blocked urethane, one active hydrogen-containing group-terminated organic polymer may be used alone, or two or more such organic polymers may be used in combination.

The number-average molecular weight of the active hydrogen-containing group-terminated organic polymer, as measured as a polystyrene-equivalent molecular weight by GPC, may be from 800 to 7000, from 1500 to 5000, or from 2000 to 4000.

(Polyether Polymer)

The polyether polymer is essentially a polymer having repeating units represented by the following formula (2):

—R¹—O— (2), wherein R¹ is a linear or branched alkylene group having 1 to 14 carbon atoms.

R¹ in the formula (2) may be a linear or branched alkylene group having 1 to 14, or 2 to 4, carbon atoms. Specific examples of the repeating units represented by the formula (2) include —CH₂O—, —CH₂CH₂O—, —CH₂CH(CH₃)O—, —CH₂CH(C₂H₅)O—, —CH₂C(CH₃)₂O—, and —CH₂CH₂CH₂CH₂O—. The backbone of the polyether polymer may be made up of one type of repeating units or two or more types of repeating units. In particular, a polyether polymer having a backbone composed mainly of polypropylene glycol having 50 wt % or more of propylene oxide units as repeating units is preferred in terms of T-peel bond strength. Polytetramethylene glycol (PTMG) obtained by ring-opening polymerization of tetrahydrofuran is preferred in terms of dynamic cleavage resistance.

(Polyether Polyol and Polyetheramine)

The polyether polyol is a polyether polymer terminated by hydroxy groups, and the polyetheramine is a polyether polymer terminated by amino or imino groups.

(Polyacrylic Polyol)

An example of the polyacrylic polyol is a polyol whose backbone is a (meth)acrylic alkyl ester (co)polymer and which has hydroxy groups in the molecule. In particular, a polyacrylic polyol obtained by copolymerization of a hydroxy group-containing (meth)acrylic alkyl ester monomer such as 2-hydroxyethyl methacrylate.

(Polyester Polyol)

An example of the polyester polyol is a polymer obtained by allowing polycondensation of a polybasic acid or its anhydride and a polyhydric alcohol to take place in the presence of an esterification catalyst in a temperature range of 150 to 270° C. Examples of the polybasic acid include maleic acid, fumaric acid, adipic acid, and phthalic acid, and examples of the polyhydric alcohol include ethylene glycol, propylene glycol, 1,4-butanediol, 1,6-hexanediol, diethylene glycol, dipropylene glycol, and neopentyl glycol. Other examples of the polyester polyol include: a product of ring-opening polymerization of ε-polycaprolactone or valerolactone; and an active hydrogen compound such as polycarbonate diol or castor oil which has two or more active hydrogen atoms.

(Polydiene Polyol)

Examples of the polydiene polyol include polybutadiene polyol, polyisoprene polyol, and polychloroprene polyol. In particular, polybutadiene polyol is preferred.

(Polyolefin Polyol)

Examples of the polyolefin polyol include polyisobutylene polyol and hydrogenated polybutadiene polyol.

(Polyisocyanate Compound)

Specific examples of the polyisocyanate compound include: aromatic polyisocyanates such as toluene (tolylene) diisocyanate, diphenylmethane diisocyanate, and xylylene diisocyanate; and aliphatic polyisocyanates such as isophorone diisocyanate, hexamethylene diisocyanate, hydrogenated toluene diisocyanate, and hydrogenated diphenylmethane diisocyanate. Among these, the aliphatic polyisocyanates are preferred in terms of heat resistance. In terms of availability, isophorone diisocyanate and hexamethylene diisocyanate are more preferred.

(Blocking Agent)

Examples of the blocking agent include a primary amine blocking agent, a secondary amine blocking agent, an oxime blocking agent, a lactam blocking agent, an active methylene blocking agent, an alcohol blocking agent, a mercaptan blocking agent, an amide blocking agent, an imide blocking agent, a heterocyclic aromatic compound blocking agent, a hydroxy-functionalized (meth)acrylate blocking agent, and a phenolic blocking agent. Among these, the oxime blocking agent, the lactam blocking agent, the hydroxy-functionalized (meth)acrylate blocking agent, and the phenolic blocking agent are preferred. The hydroxy-functionalized (meth)acrylate blocking agent and the phenolic blocking agent are more preferred, and the phenolic blocking agent is even more preferred.

(Primary Amine Blocking Agent)

Examples of the primary amine blocking agent include butylamine, isopropylamine, dodecylamine, cyclohexylamine, aniline, and benzylamine. Examples of the secondary amine blocking agent include dibutylamine, diisopropylamine, dicyclohexylamine, diphenylamine, dibenzylamine, morpholine, and piperidine. Examples of the oxime blocking agent include formaldoxime, acetaldoxime, acetoxime, methyl ethyl ketoxime, diacetyl monoxime, and cyclohexane oxime. Examples of the lactam blocking agent include ε-caprolactam, δ-valerolactam, γ-butyrolactam, and β-butyrolactam. Examples of the active methylene blocking agent include ethyl acetoacetate and acetylacetone. Examples of the alcohol blocking agent include methanol, ethanol, propanol, isopropanol, butanol, amyl alcohol, cyclohexanol, 1-methoxy-2-propanol, ethylene glycol monomethyl ether, ethylene glycol monoethyl ether, propylene glycol monomethyl ether, benzyl alcohol, methyl glycolate, butyl glycolate, diacetone alcohol, methyl lactate, and ethyl lactate. Examples of the mercaptan blocking agent include butyl mercaptan, hexyl mercaptan, decyl mercaptan, t-butyl mercaptan, thiophenol, methylthiophenol, and ethylthiophenol. Examples of the amide blocking agent include acetamide and benzamide. Examples of the imide blocking agent include succinimide and maleimide. Examples of the heterocyclic aromatic compound blocking agent include: imidazoles such as imidazole and 2-ethylimidazole; pyrroles such as pyrrole, 2-methylpyrrole, and 3-methylpyrrole; pyridines such as pyridine, 2-methylpyridine, and 4-methylpyridine; and diazabicycloalkenes such as diazabicycloundecene and diazabicyclononene.

(Hydroxy-Functionalized (Meth)acrylate Blocking Agent)

The hydroxy-functionalized (meth)acrylate blocking agent is a (meth)acrylate having one or more hydroxy groups. Specific examples of the hydroxy-functionalized (meth)acrylate blocking agent include 2-hydroxyethyl (meth)acrylate, 2-hydroxypropyl (meth)acrylate, 4-hydroxybutyl (meth)acrylate, and 2-hydroxybutyl (meth)acrylate.

(Phenolic blocking Agent)

The phenolic blocking agent has at least one phenolic hydroxy group, i.e., at least one hydroxy group directly attached to a carbon atom of an aromatic ring. The phenolic compound may contain two or more phenolic hydroxy groups, or may contain only one phenolic hydroxy group. The phenolic compound may contain another substituent. The other substituent may be one that does not react with isocyanate groups under the capping reaction conditions, or an alkenyl group or an allyl group. Further examples of the other substituent include: alkyl groups such as linear alkyl, branched alkyl, and cycloalkyl groups; aromatic groups such as phenyl, alkyl-substituted phenyl, and alkenyl-substituted phenyl groups; aryl-substituted alkyl groups; and phenol-substituted alkyl groups. Specific examples of the phenolic blocking agent include phenol, cresol, xylenol, chlorophenol, ethylphenol, allylphenol (in particular, o-allylphenol), resorcinol, catechol, hydroquinone, bisphenol, bisphenol A, bisphenol AP (1,1-bis(4-hydroxyphenyl)-1-phenylethane), bisphenol F, bisphenol K, bisphenol M, tetramethylbiphenol, and 2,2′-diallyl-bisphenol A.

The blocking agent may be attached to an end of the polymer chain of the urethane prepolymer in such a manner that the end to which the blocking agent is attached does not have any reactive group.

One blocking agent may be used alone, or two or more blocking agents may be used in combination.

The blocked urethane may contain a residue of a crosslinking agent or a residue of a chain extending agent or both.

(Crosslinking Agent)

The molecular weight of the crosslinking agent may be 750 or less or from 50 to 500. The crosslinking agent is a polyol or polyamine compound having at least three hydroxy, amino, and/or imino groups per molecule. The crosslinking agent is useful in allowing the blocked urethane to have a branched chain and increasing the functionality (i.e., the number of capped isocyanate groups per molecule) of the blocked urethane.

(Chain Extending Agent)

The molecular weight of the chain extending agent may be 750 or less or from 50 to 500. The chain extending agent is a polyol or polyamine compound having two hydroxy, amino, and/or imino groups per molecule. The chain extending agent is useful in increasing the molecular weight of the blocked urethane without increasing the functionality of the blocked urethane.

Specific examples of the crosslinking agent or chain extending agent include trimethylolpropane, glycerin, trimethylolethane, ethylene glycol, diethylene glycol, propylene glycol, dipropylene glycol, sucrose, sorbitol, pentaerythritol, ethylenediamine, triethanolamine, monoethanolamine, diethanolamine, piperazine, and aminoethylpiperazine. Other examples include compounds having two or more phenolic hydroxy groups, such as resorcinol, catechol, hydroquinone, bisphenol, bisphenol A, bisphenol AP (1,1-bis(4-hydroxyphenyl)-1-phenylethane), bisphenol F, bisphenol K, bisphenol M, tetramethylbiphenol, and 2,2′-diallyl-bisphenol A.

In the case where the blocked urethane is used as the component (B), the amount of the blocked urethane may be from 1 to 100 parts by weight, from 2 to 80 parts by weight, from 3 to 60 parts by weight, from 4 to 50 parts by weight, or from 5 to 40 parts by weight per 100 parts by weight of the epoxy resin (A), in terms of the balance between the heat resistance of the resulting cured product and the toughness enhancing effect on the resulting cured product.

The core-shell polymer particles and the blocked urethane may be used in combination as the component (B). In this case, the total amount of the core-shell polymer particles and the blocked urethane may be from 1 to 100 parts by weight, from 2 to 80 parts by weight, from 3 to 60 parts by weight, from 4 to 55 parts by weight, or from 5 to 50 parts by weight per 100 parts by weight of the epoxy resin (A), in terms of the balance among the handleability of the resulting one-part curable resin composition, the heat resistance of the resulting cured product, and the toughness enhancing effect on the resulting cured product. In the case where the core-shell polymer particles and the blocked urethane are used in combination, the ratio (by weight) of the core-shell polymer particles to the blocked urethane may be from 0.1 to 10, from 0.2 to 5, or from 0.3 to 3.

<Compound (C) Having One to Three Phenolic Hydroxy Groups per Molecule>

The compound (C) having one to three phenolic hydroxy groups per molecule is a component that controls the crosslink density of the epoxy resin (A) to improve the impact peel performance of the cured product. This compound will also be referred to as “phenolic compound (C)” hereinafter.

An epoxy resin curing process using dicyandiamide as a curing agent is presumed to take place as follows (see KAMON Takashi et al., Japanese Journal of Polymer Science and Technology, Vol. 34, No. 7, 537-543). Upon heating of a composition containing the epoxy resin (A) and the dicyandiamide (D), cyanamide derived from the dicyandiamide (D) first reacts with the epoxy resin (A) to form a linear polymer having hydroxy groups and cyano groups. Subsequently, a reaction of the hydroxy groups with the cyano groups occurs between the molecules of the linear polymer to form a three-dimensional crosslinked structure. Thus, the composition cures.

When the phenolic compound (C) is present during this process, the phenolic hydroxy groups of the phenolic compound (C) react with some of the cyano groups to partially inhibit the reaction between the hydroxy and cyano groups of the linear polymer, thereby reducing the crosslink density of the three-dimensional crosslinked structure. This is inferred to increase the molecular weight between crosslinks of the cured product, thus enabling the cured product to plastically deform easily and exhibit improved impact peel performance. If a compound having four or more phenolic hydroxy groups per molecule is used instead of the compound (C) having one to three phenolic hydroxy groups per molecule, the crosslink density increases, so that the cured product is brittle and has low impact peel performance.

The phenolic compound (C) is a compound having one to three phenolic hydroxy groups per molecule and may or may not have a substituent other than the phenolic hydroxy groups on an aromatic ring. Examples of the substituent other than the phenolic hydroxy groups include, but are not limited to: hydrocarbon groups such as alkyl, alkenyl, aryl, and aralkyl groups; and halogens such as chlorine, bromine, and iodine. The number of the carbon atoms of the hydrocarbon groups is not limited to a particular range and may be, for example, from 1 to 20, from 1 to 10, from 1 to 6, or from 1 to 4. Among the hydrocarbon groups, an alkyl group is preferred in order to give a cured product having good properties. A t-butyl group or methyl group is more preferred, and a methyl group is particularly preferred.

Examples of the phenolic compound (C) having one phenolic hydroxy group include phenol, 2-methylphenol, 3-methylphenol, 4-methylphenol, 2-methoxyphenol, 3-methoxyphenol, 4-methoxyphenol, 2,3-xylenol, 2,4-xylenol, 2,5-xylenol, 2,6-xylenol, 3,4-xylenol, 3,5-xylenol, 4-ethylphenol, 2-propylphenol, 4-propylphenol, 4-isopropylphenol, 2,3,4-trimethylphenol, 2,3,5-trimethylphenol, 2,3,6-trimethylphenol, 2,4,6-trimethylphenol, 2-tert-butylphenol, 3-tert-butylphenol, 4-tert-butylphenol, 2-methyl-6-tert-butylphenol, 3-methyl-6-tert-butylphenol, 6-tert-butyl-2,4-xylenol, 4-methyl-2-tert-butylphenol, 4-cyclohexylphenol, 2-cyclohexyl-5-methylphenol, 4-iodophenol, 2,6-di-tert-butylphenol, 2,6-di-tert-butyl-p-cresol, 2,6-di-tert-butyl-4-methoxyphenol, octadecyl 3-(3,5-di-tert-butyl-4-hydroxyphenyl)propionate, and octadecyl 3-(3,5-di-tert-butyl-4-hydroxyphenyl)propionate.

Examples of the compound (C) having two phenolic hydroxy groups include: resorcinol, catechol, 4-tert-butylcatechol, bisphenol A, tetrabromobisphenol A, bisphenol AP, bisphenol B, bisphenol E, bisphenol F, bisphenol G, bisphenol M, bisphenol S, bisphenol Z, hydroquinone, 2,5-dichlorohydroquinone, methylhydroquinone, tert-butylhydroquinone, 2,5-di-tert-butylhydroquinone, 2,2′-diallyl bisphenol A, 2,2′-methylenebisphenol, 2,2′-methylenebis(4-methylphenol), 4,4′-methylenebis(2-methylphenol), 4,4′-methylenebis(2,5-dimethylphenol), 4,4′-methylenebis(2,6-dimethylphenol), 4,4′-isopropylidenebis(2-methylphenol), 4,4′-isopropylidenebis(2,6-dimethylphenol), 4,4′-biphenol, 2,2′-biphenol, [ethylenebis(oxyethylene)] bis[3-(3-tert-butyl-4-hydroxy-5-methylphenyl)propionate)], 2,2′,6,6′-tetra-tert-butyl-4,4′-dihydroxybiphenyl, thiobisethylene bis[3-(3,5-di-tert-butyl-4-hydroxyphenyl)propionate], and 1,6-hexanediyl bis[3-(3,5-di-tert-butyl-4-hydroxyphenyl)propionate].

Examples of the compound (C) having three phenolic hydroxy groups include pyrogallol, hydroxyquinol, phloroglucinol, 4,4′,4″-ethylidynetrisphenol, 1,3,5-tris(3,5-di-tert-butyl-4-hydroxybenzyl)isocyanuric acid, and 2,4,6-tris(3′,5′-di-tert-butyl-4′-hydroxybenzyl)mesitylene.

One phenolic compound (C) may be used alone, or two or more phenolic compounds (C) may be used in combination.

The phenolic compound (C) may be a compound having one or two phenolic hydroxy groups per molecule in terms of enhancing the impact peel performance and at the same time ensuring the storage stability of the one-part curable resin composition.

The phenolic compound (C) may be a compound having two phenolic hydroxy groups per molecule in terms of enhancing both the impact peel performance and heat resistance of the cured product. With the use of the compound having two phenolic hydroxy groups, the cured product suffers a smaller decrease in glass transition point and has higher impact peel performance than with the use of a compound having one phenolic hydroxy group.

The phenolic compound (C) may be a compound having one phenolic hydroxy group per molecule in terms of the storage stability of the one-part curable resin composition and the moist heat resistance of the cured product.

The phenolic compound (C) may be an unsubstituted phenolic compound but is a phenolic compound having a substituent. This is because the steric hindrance of the substituent can improve the storage stability of the one-part curable resin composition and the moist heat resistance of the cured product. When a substituent is located on an aromatic ring of the phenolic compound (C), the steric hindrance of the substituent can reduce the reactivity of the phenolic hydroxy group to allow the one-part curable resin composition to have high storage stability. Additionally, when a substituent is located on an aromatic ring of the phenolic compound (C), the steric hindrance of the substituent can inhibit hydrolysis induced by water molecules, thus resulting in improved moist heat resistance of the cured product. Specifically, the phenolic compound (C) may have, on an aromatic ring, a substituent selected from the group consisting of a methyl group, a primary alkyl group, a secondary alkyl group, a tertiary alkyl group, and a halogen. In terms of the storage stability improvement achieved by the steric hindrance of the substituent, the substituent may be a primary alkyl group, a secondary alkyl group, a tertiary alkyl group, or a halogen and a tertiary alkyl group. The number of the substituents may be from one to four or one or two per molecule of the phenolic compound (C).

The substituent may be attached at an ortho position relative to at least one phenolic hydroxy group. When the substituent is located at the ortho position relative to the phenolic hydroxy group, the steric hindrance of the substituent can more effectively reduce the reactivity of the phenolic hydroxy group to allow the one-part curable resin composition to have higher storage stability. Additionally, when the substituent is located at the ortho position relative to the phenolic hydroxy group, the steric hindrance of the substituent can more effectively inhibit hydrolysis induced by water molecules, thus resulting in further improved moist heat resistance of the cured product.

In terms of the storage stability of the one-part curable resin composition and the moist heat resistance of the cured product, the phenolic compound (C) may have one or two substituents at ortho positions relative to each phenolic hydroxy group or may have two substituents at ortho positions relative to each phenolic hydroxy group. In the case where the phenolic compound (C) has two substituents at ortho positions relative to each phenolic hydroxy group, the phenolic compound (C) may have a tertiary alkyl group and a substituent selected from the group consisting of a methyl group, a primary alkyl group, a secondary alkyl group, and a halogen, or may have a methyl group and a tert-butyl group. Specific examples of such a phenolic compound (C) include 2-methyl-6-tert-butylphenol, 6-tert-butyl-2,4-xylenol, and [ethylenebis(oxyethylene)] bis[3-(3-tert-butyl-4-hydroxy-5-methylphenyl)propionate)].

In the case where the phenolic compound (C) has two substituents at ortho positions relative to each phenolic hydroxy group, the phenolic compound (C) may be a compound called hindered phenol which has tertiary alkyl groups at all of the ortho positions relative to each phenolic hydroxy group. In such a phenolic compound, the tertiary alkyl groups, which are bulky, are located at both of the two positions adjacent to each phenolic hydroxy group. Thus, the steric hindrance of the tertiary alkyl groups can further improve the storage stability of the one-part curable resin composition.

Examples of the compound having tertiary alkyl groups at all of the ortho positions relative to each phenolic hydroxy group include 2,6-di-tert-butylphenol, 2,6-di-tert-butyl-p-cresol, 2,6-di-tert-butyl-4-methoxyphenol, 2,2′,6,6′-tetra-tert-butyl-4,4′-dihydroxybiphenyl, octadecyl 3-(3,5-di-tert-butyl-4-hydroxyphenyl)propionate, octadecyl 3-(3,5-di-tert-butyl-4-hydroxyphenyl)propionate, thiobisethylene bis[3-(3,5-di-tert-butyl-4-hydroxyphenyl)propionate], 1,6-hexanediyl bis[3-(3,5-di-tert-butyl-4-hydroxyphenyl)propionate], 1,3,5-tris(3,5-di-tert-butyl-4-hydroxybenzyl)isocyanuric acid, and 2,4,6-tris(3′,5′-di-tert-butyl-4′-hydroxybenzyl)mesitylene. The phenolic compound (C) may be a phenolic compound that is not classifiable as the compound having tertiary alkyl groups at all of the ortho positions relative to each phenolic hydroxy group.

It should be noted that a compound having one to three phenolic hydroxy groups per molecule and further having an amino group in addition to the phenolic hydroxy groups is not considered the phenolic compound (C) as defined herein because such an amino group-containing compound could impair the storage stability required of the one-part curable resin composition. Examples of the compound having a phenolic hydroxy group and further having an amino group include 2,4,6-tris(dimethylaminomethyl)phenol and 2-(dimethylaminomethyl)phenol.

Nevertheless, the one-part curable resin composition according to one or more embodiments may further contain a compound having a phenolic hydroxy group and an amino group in addition to the phenolic compound (C) as long as the amount of the compound having a phenolic hydroxy group and an amino group is small enough so that the storage stability of the composition is not impaired. The amount which is small enough so that the storage stability of the composition is not impaired may be, for example, 0.1 parts by weight or less, 0.05 parts by weight or less, or 0.01 parts by weight or less per 100 parts by weight of the epoxy resin (A). However, the one-part curable resin composition according to one or more embodiments may be free of any compound having a phenolic hydroxy group and an amino group.

The phenolic compound (C) may be a low-molecular-weight phenolic compound rather than a phenolic resin. The molecular weight of the low-molecular-weight phenolic compound may be from 90 to 500.

In order for the incorporation of the phenolic compound (C) to exert an enhancing effect on the impact peel performance, the amount of the compound is such as to satisfy the requirements described below. When the phenolic compound (C) is a compound having one phenolic hydroxy group per molecule, the ratio of the number of moles of the phenolic hydroxy groups of the phenolic compound (C) to the number of moles of CN groups derived from the dicyandiamide (D) is from 0.01 to 0.39. If the ratio is less than 0.01, the decrease in crosslink density and the corresponding enhancing effect on the impact peel performance could be insufficient. If the ratio is more than 0.39, the crosslink density could decrease excessively so that the resulting cured product could have low strength and fail to enjoy a sufficient enhancing effect on the impact peel performance. The ratio may be from 0.05 to 0.35, from 0.08 to 0.30, or from 0.10 to 0.25.

When the phenolic compound (C) is a compound having two or three phenolic hydroxy groups per molecule, the ratio of the number of moles of the phenolic hydroxy groups of the phenolic compound (C) to the number of moles of CN groups derived from the dicyandiamide (D) is from 0.01 to 1.5. If the ratio is less than 0.01, the decrease in crosslink density and the corresponding enhancing effect on the impact peel performance could be insufficient. If the ratio is more than 1.5, the crosslink density could decrease excessively so that the resulting cured product could have low strength and fail to enjoy a sufficient enhancing effect on the impact peel performance. The ratio may be from 0.20 to 1.4, from 0.30 to 1.3, or from 0.60 to 1.0. Heating dicyandiamide causes its decomposition leading to formation of two molecules of cyanamide (compound having a CN group) from each dicyandiamide molecule. The “number of moles of CN groups derived from the dicyandiamide (D)” refers to the theoretical number of moles of the CN groups of the cyanamide, and the theoretical number of moles is calculated on the assumption that the whole amount of the dicyandiamide is converted into the cyanamide.

<Dicyandiamide (D)>

The dicyandiamide (D) forms cyanamide when heated. This enables crosslinking of the epoxy resin (A). Thus, the dicyandiamide (D) can function as a latent curing agent that exhibits activity upon heating. The incorporation of the dicyandiamide (D) renders it possible to make a one-part curable resin composition.

The amount of the dicyandiamide (D) can be set as appropriate depending on the desired physical properties. In terms of enhancing the impact peel performance, the amount of the dicyandiamide (D) may be from 2 to 20 parts by weight, from 3 to 18 parts by weight, from 4 to 16 parts by weight, from 5 to 14 parts by weight, or from 6 to 12 parts by weight per 100 parts by weight of the epoxy resin (A).

Further, in terms of not only enhancing the impact peel performance but also reducing water absorption of the cured product, the ratio of the molar amount of the dicyandiamide (D) to the molar amount of the epoxy groups of the epoxy resin (A) may be from 0.10 to 0.30, from 0.12 to 0.28, or from 0.15 to 0.26.

<Compound (E) Having Four or More Phenolic Hydroxy Groups per Molecule>

The one-part curable resin composition of one or more embodiments may further contain a compound (E) having four or more phenolic hydroxy groups per molecule in addition to the components (A) to (D). Examples of this compound include a novolac phenolic resin and pentaerythritol tetrakis[3-(3,5-di-tert-butyl-4-hydroxyphenyl)propionate].

The amount of the compound (E) can be set as appropriate by those skilled in the art. In terms of the impact peel performance, the ratio of the total weight of the compound (E) to the total weight of the phenolic compound (C) may be less than 1, less than 0.5, or less than 0.1. The compound (E) need not be contained.

<Curing Accelerator (F)>

The one-part curable resin composition of one or more embodiments may contain a curing accelerator (F). The component (F) can accelerate the curing reaction of the epoxy resin (A) with the dicyandiamide (D).

Examples of the component (F) include: ureas such as p-chlorophenyl-N,N-dimethylurea (trade name: Monuron), 3-phenyl-1,1-dimethylurea (trade name: Phenuron), 3,4-dichlorophenyl-N,N-dimethylurea (trade name: Diuron), N-(3-chloro-4-methylphenyl)-N′,N′-dimethylurea (trade name: Chlortoluron), and 1,1-dimethylphenylurea (trade name: Dyhard); and 6-caprolactam. One component (F) may be used alone, or two or more components (F) may be used in combination. The component (F) used may be enclosed in any receptacle or may be a latent component that exhibits activity only when heated.

When the component (F) is contained, the amount of the component (F) may be from 0.1 to 10 parts by weight, from 0.2 to 5 parts by weight, from 0.5 to 3 parts by weight, or from 0.8 to 2 parts by weight per 100 parts by weight of the epoxy resin (A) in terms of the curability improving effect and the storage stability.

<Toughener>

The one-part curable resin composition of one or more embodiments may contain, if necessary, a non-epoxidized rubber polymer as a toughener for the purpose of further improving the properties such as toughness, impact resistance, shear bond performance, and peel bond performance. One toughener may be used alone, or two or more tougheners may be used in combination.

<Non-Epoxidized Rubber Polymer>

The one-part curable resin composition of one or more embodiments may contain, if necessary, an unmodified rubber polymer that has not been reacted with any epoxy resin.

Examples of the rubber polymer include rubber polymers such as acrylonitrile-butadiene rubber (NBR), styrene-butadiene rubber (SBR), hydrogenated nitrile rubber (HNBR), ethylene propylene rubber (EPDM), acrylic rubber (ACM), butyl rubber (IIR), butadiene rubber, and polyoxyalkylenes such as polypropylene oxide, polyethylene oxide, and polytetramethylene oxide. The rubber polymer may be terminated by reactive groups such as amino, hydroxy, or carboxyl groups. Among the above rubber polymers, NBR and polyoxyalkylenes are preferred in terms of the bond performance or impact peel performance of the resulting one-part curable resin composition. NBR is more preferred, and carboxyl-terminated NBR (CTBN) is particularly preferred.

The glass transition temperature (Tg) of the rubber polymer is not limited to a particular range, but may be −25° C. or lower, −35° C. or lower, −40° C. or lower, or −50° C. or lower.

The number-average molecular weight of the rubber polymer, as measured as a polystyrene-equivalent molecular weight by GPC, may be from 1500 to 40000, from 3000 to 30000, or from 4000 to 20000. The dispersity (the ratio of the weight-average molecular weight to the number-average molecular weight) may be from 1 to 4, from 1.2 to 3, or from 1.5 to 2.5.

One rubber polymer may be used alone, or two or more rubber polymers may be used in combination.

The amount of the rubber polymer used may be from 1 to 30 parts by weight, from 2 to 20 parts by weight, or from 5 to 10 parts by weight per 100 parts by weight of the epoxy resin (A). When the amount of the rubber polymer is 1 part by weight or more, the enhancing effects on the properties such as the toughness, impact resistance, and bond performance are good. When the amount of the rubber polymer is 50 parts by weight or less, the resulting cured product has a high elastic modulus.

<Inorganic Filler>

The one-part curable resin composition of one or more embodiments may contain an inorganic filler. The inorganic filler used can be, for example, silicic acid and/or a silicate. Specific examples of the inorganic filler include dry silica, wet silica, aluminum silicate, magnesium silicate, calcium silicate, wollastonite, and talc.

The dry silica is also called fumed silica, examples of which include hydrophilic fumed silica without surface treatment and hydrophobic fumed silica produced by chemically treating silanol group portions of hydrophilic fumed silica with silane or siloxane. In terms of dispersibility in the component (A), hydrophobic fumed silica is preferred.

Other examples of the inorganic filler include: reinforcing fillers such as dolomite and carbon black; ground calcium carbonate; colloidal calcium carbonate; magnesium carbonate; titanium oxide; iron(III) oxide; aluminum fines; zinc oxide; and activated zinc oxide.

The inorganic filler may be surface-treated with a surface treatment agent. The surface treatment increases the dispersibility of the inorganic filler in the composition, leading to improved physical properties of the resulting cured product.

One inorganic filler may be used alone, or two or more inorganic fillers may be used in combination.

The amount of the inorganic filler used may be from 1 to 100 parts by weight, from 2 to 70 parts by weight, from 5 to 40 parts by weight, or from 7 to 20 parts by weight per 100 parts by weight of the component (A).

<Calcium Oxide>

The one-part curable resin composition of one or more embodiments may contain calcium oxide.

The calcium oxide reacts with and removes water in the one-part curable resin composition, thus solving various water-induced problems concerning the physical properties. For example, the calcium oxide functions as an antifoaming agent for removing water to prevent bubble formation, and reduces the decrease in bond strength.

The calcium oxide may be surface-treated with a surface treatment agent. The surface treatment increases the dispersibility of the calcium oxide in the composition. Consequently, the physical properties such as bond strength of the resulting cured product are better than when non-surface-treated calcium oxide is used. In particular, the T-peel bond performance and the impact peel performance are significantly improved. The surface treatment agent may be, but not limited to, a fatty acid.

The amount of the calcium oxide used may be from 0.1 to 10 parts by weight, from 0.2 to 5 parts by weight, from 0.5 to 3 parts by weight, or from 1 to 2 parts by weight per 100 parts by weight of the component (A). When the amount of the calcium oxide is 0.1 parts by weight or more, the water removing effect is good. When the amount of the calcium oxide is 10 parts by weight or less, the resulting cured product has high strength.

One type of calcium oxide may be used alone, or two or more types of calcium oxide may be used in combination.

<Radical-Curable Resin>

The one-part curable resin composition of one or more embodiments may contain, if necessary, a radical-curable resin having two or more double bonds in the molecule. If necessary, a low-molecular-weight compound having at least one double bond in the molecule and having a molecular weight of less than 300 may be added. The low-molecular-weight compound, when used in combination with the radical-curable resin, serves to adjust the viscosity, the cured product physical properties, and the curing rate, and functions as what may be called a reactive diluent for the radical-curable resin. A radical polymerization initiator may be further added to the one-part curable resin composition of one or more embodiments. The radical polymerization initiator may be of a latent type that is activated at a raised temperature (from about 50° C. to about 150° C.).

Examples of the radical-curable resin include an unsaturated polyester resin, polyester (meth)acrylate, epoxy (meth)acrylate, urethane (meth)acrylate, polyether (meth)acrylate, and acrylic (meth)acrylate. One of these resins may be used alone, or two or more thereof may be used in combination. Specific examples of the radical-curable resin include compounds as mentioned in WO 2014-115778. Specific examples of the low-molecular-weight compound and the radical polymerization initiator include compounds as mentioned in WO 2014-115778.

As described in WO 2010-019539, when a radical polymerization initiator is activated at a temperature different from the curing temperature of an epoxy resin, partial curing of a one-part curable resin composition can be achieved by polymerizing the radical-curable resin selectively. This partial curing allows the composition to increase its viscosity after being applied and exhibit improved wash-off resistance. During a water showering step in a production line for vehicles or the like, an uncured adhesive composition could be melted in part, scattered, or deformed due to the water shower pressure to adversely affect the corrosion resistance of a steel sheet of a part with the composition applied thereto or reduce the stiffness of the steel sheet. The “wash-off resistance” refers to the resistance to this phenomenon. Additionally, the partial curing allows for temporary joint (temporary bonding) of two substrates before completion of curing of the composition. In this case, the free radical initiator may be activated upon heating to a temperature of 80 to 130° C., or 100 to 120° C.

<Monoepoxide>

The one-part curable resin composition of one or more embodiments may contain a monoepoxide if necessary. The monoepoxide can function as a reactive diluent. Specific examples of the monoepoxide include: aliphatic glycidyl ethers such as butyl glycidyl ether; aromatic glycidyl ethers such as phenyl glycidyl ether and cresyl glycidyl ether; ethers such as 2-ethylhexyl glycidyl ether which are composed of an alkyl group having 8 to 10 carbon atoms and a glycidyl group; ethers such as p-tert-butylphenyl glycidyl ether which are composed of a phenyl group having 6 to 12 carbon atoms and a glycidyl group, the phenyl group being optionally substituted with an alkyl group having 2 to 8 carbon atoms; ethers such as dodecyl glycidyl ether which are composed of an alkyl group having 12 to 14 carbon atoms and a glycidyl group; aliphatic glycidyl esters such as glycidyl (meth)acrylate and glycidyl maleate; glycidyl esters such as glycidyl versatate, glycidyl neodecanoate, and glycidyl laurate which are glycidyl esters of aliphatic carboxylic acids having 8 to 12 carbon atoms; and glycidyl p-t-butylbenzoate.

When the monoepoxide is used, the amount of the monoepoxide used may be from 0.1 to 20 parts by weight, from 0.5 to 10 parts by weight, or from 1 to 5 parts by weight per 100 parts by weight of the component (A). When the amount of the monoepoxide is 0.1 parts by weight or more, the viscosity reducing effect is good. When the amount of the monoepoxide is 20 parts by weight or less, the physical properties such as bond performance are good.

<Photopolymerization Initiator>

In the case where the one-part curable resin composition of one or more embodiments is photo-cured, a photopolymerization initiator may be added. Examples of the photopolymerization initiator include cationic photopolymerization initiators (photoacid generators) such as onium salts (e.g., aromatic sulfonium salts and aromatic iodonium salts), aromatic diazonium salts, and metallocene salts of anions such as hexafluoroantimonate, hexafluorophosphate, and tetraphenylborate. One of these photopolymerization initiators may be used alone, or two or more thereof may be used in combination.

<Other Components>

In one or more embodiments, other components may be used if necessary. Examples of the other components include: an expansion agent such as an azo-type chemical blowing agent or a thermally-expandable microballoon; fiber pulp such as aramid pulp; a colorant such as a pigment or a dye; an extender pigment; an ultraviolet absorber; an antioxidant; a stabilizing agent (gelation inhibitor); a plasticizer; a leveling agent; a defoamer; a silane coupling agent; an antistatic agent; a flame retardant; a lubricant; a viscosity reducer; a low profile additive; an organic filler; a thermoplastic resin; a drying agent; and a dispersant.

<Method for Producing One-Part Curable Resin Composition>

In the case where the one-part curable resin composition of one or more embodiments contains the epoxy resin (A) which is a curable resin and core-shell polymer particles as the component (B), the composition may be one that contains the core-shell polymer particles (B) dispersed as primary particles.

Any of various methods can be used to obtain such a composition containing the core-shell polymer particles (B) dispersed as primary particles. Examples include: a method in which the core-shell polymer particles obtained in the form of a water-based latex are brought into contact with the component (A) and then unwanted components such as water are removed; and a method in which the core-shell polymer particles are extracted into an organic solvent and then mixed with the component (A) and finally the organic solvent is removed. A method as described in WO 2005/028546 may be used. To be specific, the composition may be prepared by a production method that includes in succession: a first step of mixing a water-based latex containing the core-shell polymer particles (B) (in particular, a reaction mixture resulting from production of the core-shell polymer particles by emulsion polymerization) with an organic solvent having a water solubility of 5 to 40 wt % at 20° C. and then mixing the resulting mixture with an excess of water to aggregate the polymer particles; a second step of separating the aggregated core-shell polymer particles (B) from the liquid phase to collect the aggregated core-shell polymer particles (B) and then mixing the core-shell polymer particles (B) with an organic solvent to obtain an organic solvent solution of the core-shell polymer particles (B); and a third step of mixing the organic solvent solution with the component (A) and then distilling off the organic solvent.

The component (A) may be liquid at 23° C. since in this case the third step is easy to perform. The statement that a substance is “liquid at 23° C.” means that the substance has a softening point of 23° C. or lower and exhibits fluidity at 23° C.

After the composition containing the core-shell polymer particles (B) dispersed as primary particles in the component (A) is obtained through the above steps, the composition is mixed with an additional amount of the component (A), the component (C), the component (D), and other components used if necessary. Thus, the one-part curable resin composition according to one or more embodiments can be obtained as one that contains the core-shell polymer particles (B) dispersed as primary particles.

Alternatively, the core-shell polymer particles (B) may be obtained in the form of a powder by coagulating the latex through a process such as salting-out and then drying the coagulated product, and the core-shell polymer particles (B) may be dispersed in the component (A) using a dispersing machine such as a three-roll paint mill, roll mill, or kneader which exerts a strong mechanical shear force. In this case, the component (B) can be efficiently dispersed by applying a mechanical shear force to the components (A) and (B) at a high temperature. The temperature during the dispersing process may be from 50 to 200° C., from 70 to 170° C., from 80 to 150° C., or from 90 to 120° C.

The one-part curable resin composition of one or more embodiments has high storage stability and is thus used as a one-part composition all the components of which are mixed together and hermetically stored and which cures upon heating or light irradiation after being applied.

<Cured Product>

A cured product can be obtained by curing the one-part curable resin composition of one or more embodiments. In the case where the one-part curable resin composition contains core-shell polymer particles as the component (B), the core-shell polymer particles (B) are uniformly dispersed in the cured product. In a preferred aspect, the one-part curable resin composition has a low viscosity and is highly workable to obtain the cured product.

The cured product can be produced by mixing the components (A) to (D) and other components used if necessary and heating the resulting mixture at a curing temperature as described later. The phrase “mixing the components (A) to (D) and other components used if necessary” is intended to include the case as described above where a composition containing the core-shell polymer particles (B) dispersed as primary particles in the component (A) is prepared first and the composition is mixed with an additional amount of the component (A), the component (C), the component (D), and other components used if necessary. In producing the cured product by mixing the components, there is no need for the step of preliminarily reacting the epoxy resin (A) with the phenolic compound (C) to allow the epoxy resin (A) to have a high molecular weight.

<Application Method>

The one-part curable resin composition of one or more embodiments can be applied to a substrate by any method. The one-part curable resin composition can be applied at a low temperature around room temperature and may be heated if necessary before application. The one-part curable resin composition of one or more embodiments has high storage stability and is thus particularly useful for a process where the composition is heated before application.

The one-part curable resin composition of one or more embodiments may be extruded in the shape of a bead, a monofilament, or a swirl onto a substrate by means of an application robot or may be applied by mechanical application means such as a caulk gun or any other manual application means. The composition may be applied to a substrate using a jet spray process or streaming process. The one-part curable resin composition of one or more embodiments is applied to one or both of the two substrates to be joined, then the substrates are brought into contact such that the composition is located between the materials, and in this state the composition is cured to joint the two substrates together. The viscosity of the one-part curable resin composition is not limited to a particular range. The viscosity may be from about 150 to 600 Pas at 45° C. in the case of an extrusion bead process, about 100 Pas at 45° C. in the case of a swirl application process, or from about 20 to 400 Pas at 45° C. in the case of a high-volume application process using a high-velocity flow device.

When the one-part curable resin composition of one or more embodiments is used as an adhesive for vehicles, it is effective to enhance the thixotropy of the composition in order to improve the “wash-off resistance”. Generally, the thixotropy is enhanced using a thixotropic additive such as fumed silica or amide wax. The lower the viscosity of a thermosetting resin component that is a main component of a composition, the greater the thixotropy enhancing effect, and the more workable the composition. The one-part curable resin composition of one or more embodiments is preferred since this composition is likely to have a low viscosity and its thixotropy is easy to enhance. The viscosity of a highly thixotropic composition can be adjusted to a suitable level for application by heating the composition.

To improve the “wash-off resistance”, as described in WO 2005-118734, it is preferable to blend the one-part curable resin composition with a polymer compound having a crystalline melting point at around an application temperature at which the composition is applied. In this case, the composition has a low viscosity (is easy to apply) at the application temperature, and exhibits a high viscosity and therefore improved “wash-off resistance” at the temperature used in a water showering step. Examples of the polymer compound having a crystalline melting point at around the application temperature include various polyester resins such as crystalline or semicrystalline polyester polyols.

<Adhesive>

When various substrates are bonded together using the one-part curable resin composition of one or more embodiments as an adhesive, the substrates to be joined may be made of, for example, wood, metal, plastic, or glass. It is preferable to join automobile parts to each other and more preferable to join automobile frames to each other or join an automobile frame to another automobile part. Examples of the substrates include: steel materials such as cold-rolled steel and hot-dip galvanized steel; aluminum materials such as aluminum and coated aluminum; and plastic materials such as commodity plastics, engineering plastics, and composite materials such as CFRP and GFRP.

The one-part curable resin composition of one or more embodiments has high bond performance. Thus, when a laminate made up of a plurality of members including an aluminum substrate is obtained by attaching the members to one another with the one-part curable resin composition of one or more embodiments interposed between the adjacent members and by curing the one-part curable resin composition, the laminate exhibits high bond strength and is therefore preferred.

The one-part curable resin composition of one or more embodiments has high toughness and is thus suitable for joining between dissimilar substrates having different linear expansion coefficients.

The one-part curable resin composition of one or more embodiments can be used also for joining of aerospace structural parts, in particular exterior structural parts made of metal.

<Curing Temperature>

The curing temperature of the one-part curable resin composition of one or more embodiments is not limited to a particular range, but may be from 50 to 250° C., from 80 to 220° C., from 100 to 200° C., or from 130 to 180° C.

When the one-part curable resin composition of one or more embodiments is used as an adhesive for automobiles, it is preferable, in terms of process time reduction and process simplification, to apply the adhesive to automobile parts, then apply coatings to the automobile parts, and cure the adhesive simultaneously with baking and curing of the coatings.

<Usage>

The one-part curable resin composition of one or more embodiments may be used as any of the following: an adhesive such as a structural adhesive for vehicles, aircrafts, or wind power generation; a paint; a material for lamination with glass fibers; an electrical insulating material such as a material for printed circuit boards, a solder resist, an interlayer insulating film, a build-up material, an adhesive for FPCs, or a sealant for electronic parts such as semiconductors and LEDs; a material for semiconductor packaging such as a die-bonding material, an underfill, an ACF, an ACP, an NCF, or an NCP; and a sealant for display or lighting devices such as liquid crystal panels, OLED lights, and OLED displays. In particular, the one-part curable resin composition of one or more embodiments is useful as a structural adhesive for vehicles.

### EXAMPLES

Hereinafter, one or more embodiments of the present invention will be described in more detail using examples. One or more embodiments of the present invention are not limited to these examples.

(Measurement of Volume Mean Diameter)

Polybutadiene rubber particles in polybutadiene rubber latexes described in Production Examples and core-shell polymer particles in core-shell polymer latexes described in Production Examples were measured for their average particle sizes by the following method. The volume mean diameter (Mv) of the particles in the water-based latex was measured using Microtrac UPA150 (manufactured by Nikkiso Co., Ltd.). The latex was diluted with deionized water, and the diluted latex was used as a measurement sample. In the measurement, the refractive index of water and the refractive index of the polymer particles of interest were input to the Microtrac UPA150, the measurement time was 600 seconds, and the sample concentration was adjusted such that the Signal Level fell in the range of 0.6 to 0.8.

1. Formation of Core Layers

### Production Example 1: Preparation of Polybutadiene Rubber Latex (R-2)

A pressure-resistant polymerization reactor was charged with 200 parts by weight of water, 0.03 parts by weight of tripotassium phosphate, 0.002 parts by weight of disodium ethylenediaminetetraacetate (EDTA), 0.001 parts by weight of iron(II) sulfate heptahydrate (FE), and 1.55 parts by weight of sodium dodecylbenzenesulfonate (SDBS), and the reactor contents were thoroughly purged with nitrogen under stirring to remove oxygen. After that, 100 parts by weight of butadiene (Bd) was added to the reaction system, which was heated to 45° C. To the reaction system was added 0.03 parts by weight of p-menthane hydroperoxide (PHP), and subsequently 0.10 parts by weight of sodium formaldehyde sulfoxylate (SFS) was added to initiate polymerization. At 3, 5, and 7 hours after the initiation of the polymerization, 0.025 parts by weight of PHP was added. At 4, 6, and 8 hours after the initiation of the polymerization, 0.0006 parts by weight of EDTA and 0.003 parts by weight of FE were added. At 15 hours after the initiation of the polymerization, the residual monomer was removed by evaporation under reduced pressure, and the polymerization was terminated. Thus, a polybutadiene rubber latex (R-1) containing polybutadiene rubber as a main component was obtained. The volume mean diameter of the polybutadiene rubber particles contained in the obtained latex was 0.08 μm.

A pressure-resistant polymerization reactor was charged with 21 parts by weight of the polybutadiene rubber latex (R-1) (containing 7 parts by weight of polybutadiene rubber), 185 parts by weight of deionized water, 0.03 parts by weight of tripotassium phosphate, 0.002 parts by weight of EDTA, and 0.001 parts by weight of FE, and the reactor contents were thoroughly purged with nitrogen under stirring to remove oxygen. After that, 93 parts by weight of Bd was added to the reaction system, which was heated to 45° C. To the reaction system was added 0.02 parts by weight of PHP, and subsequently 0.10 parts by weight of SFS was added to initiate polymerization. Until 24 hours after the initiation of the polymerization, 0.025 parts by weight of PHP, 0.0006 parts by weight of EDTA, and 0.003 parts by weight of FE were added every 3 hours. At 30 hours after the initiation of the polymerization, the residual monomer was removed by evaporation under reduced pressure, and the polymerization was terminated. Thus, a polybutadiene rubber latex (R-2) containing polybutadiene rubber as a main component was obtained. The volume mean diameter of the polybutadiene rubber particles contained in the obtained latex was 0.20 μm.

2. Preparation of Core-Shell Polymer Latex (Formation of Shell Layers)

### Production Example 2-1: Preparation of Core-Shell Polymer Latex (L-1)

A glass reactor equipped with a thermometer, a stirrer, a reflux condenser, a nitrogen inlet, and a monomer adding device was charged with 262 parts by weight of the polybutadiene rubber latex (R-2) (containing 87 parts by weight of polybutadiene rubber particles) prepared in Production Example 1 and 57 parts by weight of deionized water, and the reactor contents were stirred at 60° C. under nitrogen purging. Subsequently, 0.004 parts by weight of EDTA, 0.001 parts by weight of FE, and 0.2 parts by weight of SFS were added, and after that a mixture of a shell monomer (a combination of 12 parts by weight of methyl methacrylate (MMA) and 1 part by weight of glycidyl methacrylate (GMA)) and 0.04 parts by weight of cumene hydroperoxide (CHP) was added continuously over 120 minutes. After the addition of the mixture, 0.04 parts by weight of CHP was added, and the reactor contents were further stirred for 2 hours to complete the polymerization. Thus, a water-based latex (L-1) containing core-shell polymer particles was obtained. The polymerization conversion rate of the monomer component was 99% or more. The volume mean diameter of the core-shell polymer particles contained in the water-based latex (L-1) was 0.21 μm. The amount of the epoxy groups of the shell layer of each core-shell polymer particle was 0.5 mmol/g based on the total amount of the shell layer.

### Production Example 2-2: Preparation of Core-Shell Polymer Latex (L-2)

A water-based latex (L-2) containing core-shell polymer particles was obtained in the same manner as the water-based latex of Production Example 2-1, except that the shell monomer was changed to a combination of 1 part by weight of MMA, 6 parts by weight of styrene (ST), 2 parts by weight of acrylonitrile (AN), and 4 parts by weight of GMA. The conversion rate of the monomer component was 99% or more. The volume mean diameter of the core-shell polymer particles contained in the water-based latex (L-2) was 0.21 μm. The amount of the epoxy groups of the shell layer of each core-shell polymer particle was 2.2 mmol/g based on the total amount of the shell layer.

### Production Example 2-3: Preparation of Core-Shell Polymer Latex (L-3)

A water-based latex (L-3) containing core-shell polymer particles was obtained in the same manner as the water-based latex of Production Example 2-1, except that the shell monomer was changed to a combination of 3 parts by weight of MMA, 6 parts by weight of ST, 2 parts by weight of AN, and 2 parts by weight of GMA. The conversion rate of the monomer component was 99% or more. The volume mean diameter of the core-shell polymer particles contained in the water-based latex (L-3) was 0.21 μm. The amount of the epoxy groups of the shell layer of each core-shell polymer particle was 1.1 mmol/g based on the total amount of the shell layer.

### Production Example 2-4: Preparation of Core-Shell Polymer Latex (L-4)

A water-based latex (L-4) containing core-shell polymer particles was obtained in the same manner as the water-based latex of Production Example 2-1, except that the shell monomer was changed to a combination of 4 parts by weight of MMA, 6 parts by weight of ST, 2 parts by weight of AN, and 1 part by weight of GMA. The conversion rate of the monomer component was 99% or more. The volume mean diameter of the core-shell polymer particles contained in the water-based latex (L-4) was 0.21 μm. The amount of the epoxy groups of the shell layer of each core-shell polymer particle was 0.5 mmol/g based on the total amount of the shell layer.

### Production Example 2-5: Preparation of Core-Shell Polymer Latex (L-5)

A water-based latex (L-5) containing core-shell polymer particles was obtained in the same manner as the water-based latex of Production Example 2-1, except that the shell monomer was changed to a combination of 5 parts by weight of MMA, 6 parts by weight of ST, and 2 parts by weight of AN. The conversion rate of the monomer component was 99% or more. The volume mean diameter of the core-shell polymer particles contained in the water-based latex (L-5) was 0.21 μm. The amount of the epoxy groups of the shell layer of each core-shell polymer particle was 0 mmol/g based on the total amount of the shell layer.

3. Preparation of Dispersion (M) Containing Core-Shell Polymer Particles (B) Dispersed in Curable Resin

### Production Example 3-1: Preparation of Dispersion (M-1)

An amount of 132 g of methyl ethyl ketone (MEK) was introduced into a 1 L mixing vessel at 25° C., and 132 g of the core-shell polymer latex (L-1) (corresponding to 40 g of core-shell polymer particles) obtained in Production Example 2-1 was added under stirring. After the mixture became homogeneous, 200 g of water was fed at a rate of 80 g/min. Upon completion of the water feed, the stirring was immediately stopped. As a result, a liquid slurry composed of floating aggregates and an aqueous phase containing an organic solvent in part was obtained. Next, 360 g of the aqueous phase was discharged through an outlet located at a bottom portion of the vessel while the aggregates containing a part of the aqueous phase were left in the vessel. To the aggregates thus obtained was added 90 g of MEK, and the mixture was homogenized to obtain a dispersion containing the core-shell polymer particles (B) dispersed uniformly. The dispersion was mixed with 60 g of an epoxy resin as the component (A) (JER 828 manufactured by Mitsubishi Chemical Corporation: liquid bisphenol A epoxy resin). MEK was removed from the resulting mixture using a rotary evaporator. In this manner, a dispersion (M-1) containing the core-shell polymer particles (B) dispersed in the epoxy resin (A) was obtained.

### Production Example 3-2: Preparation of Dispersion (M-2)

A dispersion (M-2) containing the core-shell polymer particles (B) in the epoxy resin (A) was obtained in the same manner as the dispersion of Production Example 3-1, except that the core-shell polymer latex (L-2) obtained in Production Example 2-2 was used instead of the core-shell polymer latex (L-1).

### Production Example 3-3: Preparation of Dispersion (M-3)

A dispersion (M-3) containing the core-shell polymer particles (B) in the epoxy resin (A) was obtained in the same manner as the dispersion of Production Example 3-1, except that the core-shell polymer latex (L-3) obtained in Production Example 2-3 was used instead of the core-shell polymer latex (L-1).

### Production Example 3-4: Preparation of Dispersion (M-4)

A dispersion (M-4) containing the core-shell polymer particles (B) in the epoxy resin (A) was obtained in the same manner as the dispersion of Production Example 3-1, except that the core-shell polymer latex (L-4) obtained in Production Example 2-4 was used instead of the core-shell polymer latex (L-1).

### Production Example 3-5: Preparation of Dispersion (M-5)

A dispersion (M-5) containing the core-shell polymer particles (B) in the epoxy resin (A) was obtained in the same manner as the dispersion of Production Example 3-1, except that the core-shell polymer latex (L-5) obtained in Production Example 2-5 was used instead of the core-shell polymer latex (L-1).

### Examples 1 to 60 and Comparative Examples 1 to 24

The components were weighed out according to the mix proportions shown in Tables 1 to 9 and thoroughly mixed to obtain one-part curable resin compositions.

For each of the compositions of Tables 1 to 9, the dynamic cleavage resistance (impact peel performance), its retention rate after moist heat exposure test, the water absorption rate, the T-peel bond strength, its retention rate after moist heat exposure test, and the viscosity increase rate (storage stability) were evaluated by the methods described below.

<Dynamic Cleavage Resistance (Impact peel performance) and Its Retention Rate after Moist Heat Exposure Test>

Each of the compositions was applied to two SPCC steel sheets, then the SPCC steel sheets were stacked together such that the adhesive layer would have a thickness of 0.25 mm, and the applied composition was cured to obtain a laminate. The curing was performed at 170° C. for 30 minutes for the compositions of Tables 1 to 5 and at 150° C. for 30 minutes for the compositions of Tables 6 to 9. The laminate was used to measure the dynamic cleavage resistance (impact peel performance) at 23° C. according to ISO 11343. The results are shown in Tables 1 to 9.

For the compositions of Table 8, the dynamic cleavage resistance was measured also after a moist heat exposure test in which the laminate was left at 70° C. and 95% RH for 21 days, and the retention rate (=strength after moist heat exposure test/strength before moist heat exposure test) was calculated. The results are shown in Table 8.

<Water Absorption Rate>

Each of the compositions of Table 1 was poured into a gap between two glass sheets between which a 3-mm-thick spacer was inserted, and the composition was cured in a hot air oven at 170° C. for 1 hour to obtain a 3-mm-thick cured sheet. The cured sheet was cut to give a cured product in the shape of a rectangular parallelepiped having a size of 3 mm×5 mm×50 mm. The weight of the rectangular parallelepiped-shaped cured product was measured before and after a moist heat exposure test in which the cured product was left at 70° C. and 95% RH for 7 days, and the water absorption rate (%) was calculated by the equation given below. The results are shown in Table 1.

Water Absorption Rate (%)=(weight after moist heat exposure test/weight before moist heat exposure test −1)×100

<T-Peel Bond Strength and Its Retention Rate after Moist Heat Exposure Test>

Each of the compositions of Tables 2, 4 to 6, 8, and 9 was applied to two SPCC steel sheets having a width of 25 mm, a length of 200 mm, and a thickness of 0.5 mm, then the two SPCC steel sheets were stacked together such that the adhesive layer would have a thickness of 0.25 mm, and the applied composition was cured to obtain a laminate. The curing was performed at 170° C. for 30 minutes for the compositions of Tables 2, 4, and 5 and at 150° C. for 30 minutes for the compositions of Tables 6, 8, and 9.

The T-peel bond strength was measured in units of N/25 mm at a measurement temperature of 23° C. and a test speed of 254 mm/min. The results are shown in Tables 2, 4 to 6, 8, and 9.

For the compositions of Tables 6 and 9, the T-peel bond strength was measured also after a moist heat exposure test in which the laminate was left at 70° C. and 95% RH for 21 days, and the retention rate (=strength after moist heat exposure test/strength before moist heat exposure test) was calculated. The results are shown in Tables 6 and 9.

<Viscosity Increase Rate (Storage Stability)>

The viscosity at 50° C. was measured for the compositions of Examples 17 to 21 and Comparative Example 8 of Table 2, the compositions of Examples 50 to 53 and Comparative Example 20 of Table 7, and the compositions of Examples 57 to 60 and Comparative Example 24 of Table 9. The measurement was performed using a rheometer at a shear rate of 5 s⁻¹. Each composition was stored at 40° C. for 14 days, after which its viscosity was measured at 50° C. and a shear rate of 5 s⁻¹ as in the measurement performed before the storage. Calculation results of the viscosity increase rate (=viscosity after storage/viscosity before storage) are shown in Tables 2, 7, and 9.

The materials listed below were used as the components shown in Tables 1 to 9. Table 10 shows the structural formulae, molecular weights, and melting points of the compounds (C) and compounds used for comparison.

<Epoxy Resin (A)>
A-1: JER 828 (manufactured by Mitsubishi Chemical Corporation, bisphenol A epoxy resin that is liquid at room temperature, epoxy equivalent weight: 184 to 194)
A-2: HyPox RA 1340 (manufactured by CVC Thermoset Specialties, rubber-modified epoxy resin, epoxy equivalent weight: 350)
A-3: EPU-73B (manufactured by ADEKA Corporation, urethane-modified epoxy resin, epoxy equivalent weight: 245)

<Dispersion (M) Containing Polymer Particles (B) Dispersed in Epoxy Resin (A)>
M-1 to M-5: Dispersions obtained in Production Examples 3-1 to 3-5 described above

<Blocked Urethane (B)>
B-1: ADEKA RESIN QR-9466 (manufactured by ADEKA Corporation, blocked urethane, blocked NCO equivalent weight: 1400 g/eq)

<Rubber Polymer>
Carboxyl-terminated acrylonitrile-butadiene copolymer: CTBN 1300×8 (manufactured by CVC Thermoset Specialties)
Carboxyl-terminated acrylonitrile-butadiene copolymer: CTBN 1300×13 (manufactured by CVC Thermoset Specialties)

<Compound (C) Having One to Three Phenolic Hydroxy Groups per Molecule>
4-tert-Butylphenol (manufactured by Tokyo Chemical Industry Co., Ltd.)
Bisphenol A (manufactured by Tokyo Chemical Industry Co., Ltd.)
Bisphenol M (manufactured by Tokyo Chemical Industry Co., Ltd.)
Phenol (manufactured by FUJIFILM Wako Pure Chemical Corporation)
4-Methoxyphenol (manufactured by FUJIFILM Wako Pure Chemical Corporation)
2,6-Xylenol (manufactured by FUJIFILM Wako Pure Chemical Corporation)
Resorcinol (manufactured by FUJIFILM Wako Pure Chemical Corporation)
Catechol (manufactured by FUJIFILM Wako Pure Chemical Corporation)
4-tert-Butylcatechol (manufactured by FUJIFILM Wako Pure Chemical Corporation)
Hydroquinone (manufactured by Tokyo Chemical Industry Co., Ltd.)
Methylhydroquinone (manufactured by FUJIFILM Wako Pure Chemical Corporation)
tert-Butylhydroquinone (manufactured by Tokyo Chemical Industry Co., Ltd.)
2,5-Di-tert-butylhydroquinone (manufactured by Tokyo Chemical Industry Co., Ltd.)
2,2′-Diallyl bisphenol A (manufactured by Konishi Chemical Ind Co., Ltd.)
Pyrogallol (manufactured by Kanto Chemical Co., Inc.)
3-Methyl-6-tert-butylphenol (manufactured by Tokyo Chemical Industry Co., Ltd.)
2-Methyl-6-tert-butylphenol (manufactured by Tokyo Chemical Industry Co., Ltd.)
[Ethylenebis(oxyethylene)] bis[3-(3-tert-butyl-4-hydroxy-5-methylphenyl)propionate)] (manufactured by BASF Japan Ltd., trade name: Irganox 245)
6-tert-Butyl-2,4-xylenol (manufactured by Tokyo Chemical Industry Co., Ltd.)
2,3,6-Trimethylphenol (manufactured by Tokyo Chemical Industry Co., Ltd.)
2,6-Di-tert-butylphenol (manufactured by Tokyo Chemical Industry Co., Ltd.)

<Phenolic Compound Not Classifiable as Component (C)>
2,4,6-Tris(dimethylaminomethyl)phenol (manufactured by Tokyo Chemical Industry Co., Ltd.)

PHENOLITE TD-2090 (manufactured by DIC Corporation, novolac phenolic resin)

<Non-Phenolic Compound>
Anisole (manufactured by Kanto Chemical Co., Inc.)

<Dicyandiamide (D)>
Dyhard 100S (manufactured by AlzChem)

<Curing Accelerator (F)>
Dyhard UR200 (manufactured by AlzChem, 1,1-dimethyl-3-(3,4-dichlorophenyl)urea)
Dyhard UR300 (manufactured by AlzChem, 1,1-dimethyl-3-phenylurea)

<Fumed Silica>
CAB-O-SIL TS-720 (manufactured by Cabot Corporation, fumed silica surface-treated with polydimethylsiloxane)

<Calcium Carbonate>
Non-treated ground calcium carbonate: WHITON SB (manufactured by Shiraishi Calcium Kaisha, Ltd., average particle size: 1.8 μm)
Colloidal calcium carbonate: Vigot-10 (Shiraishi Kogyo Kaisha, Ltd., average particle size: 0.17 μm)

<Carbon Black>
MONARCH 280 (manufactured by Cabot Corporation)

<Calcium Oxide>
CML #31 (manufactured by Ohmi Chemical Industry Co., Ltd.)

TABLE 1

| | | | | | Examples | | | | | | | | |
|---|---|---|---|---|---|---|---|---|---|---|---|---|---|
| Component proportions (parts by weight) | | | | | 1 | 2 | 3 | 4 | 5 | 6 | 7 | 8 | 9 |
| (A) | Epoxy resin | | A-1 | | 40 | 40 | 40 | 40 | 40 | 40 | 40 | 40 | 40 |
| (A) + (B) | Dispersion (M) containing polymer | | | | 100 | 100 | 100 | 100 | 100 | 100 | 100 | 100 | 100 |
| | particles (B) dispersed in (A) | | M-1 | | | | | | | | | | |
| (C) | Phenolic compound | 4-tert- | 1^{(*)} | 0^{(**)} | 4 | 8 | 11.9 | | | | | 5 | 10 |
| | | Butylphenol | | | | | | | | | | | |
| | | Bisphenol A | 2^{(*)} | 0/0^{(**)} | | | | 12.1 | 24.2 | 36.2 | | | |
| | | Bisphenol M | 2^{(*)} | 0/0^{(**)} | | | | | | | 18.3 | | |
| | Non-phenolic | Anisole | 0^{(*)} | 0^{(**)} | | | | | | | | | |
| | compound | | | | | | | | | | | | |
| (D) | Dicyandiamide | Dyhard 100S | | | 11.1 | 11.1 | 11.1 | 11.1 | 11.1 | 11.1 | 11.1 | 7 | 14 |
| (F) | Curing accelerator | Dyhard UR200 | | | 1 | 1 | 1 | 1 | 1 | 1 | 1 | 1 | 1 |
| Amount of component (B) per 100 parts of component (A) | | | | | 40 | 40 | 40 | 40 | 40 | 40 | 40 | 40 | 40 |
| Amount of component (C) per 100 parts of component (A) | | | | | 4 | 8 | 12 | 12 | 24 | 36 | 18 | 5 | 10 |
| Amount of component (D) per 100 parts of component (A) | | | | | 11 | 11 | 11 | 1. | 1. | 11 | 11 | 7 | 14 |
| Amount of component(F) per 100 parts of component (A) | | | | | 1 | 1 | 1 | 1 | 1 | 1 | 1 | 1 | 1 |
| Ratio of number of moles of phenolic OH groups of component (C) to | | | | | 0.10 | 0.20 | 0.30 | 0.40 | 0.80 | 1.20 | 0.40 | 0.20 | 0.20 |
| number of moles of CN groups derived from component (D) | | | | | | | | | | | | | |
| Ratio of molar amount of component (D) to molar amount of epoxy groups | | | | | 0.25 | 0.25 | 0.25 | 0.25 | 0.25 | 0.25 | 0.25 | 0.16 | 0.31 |
| of component (A) | | | | | | | | | | | | | |
| Dynamic cleavage resistance (kN/m) <23° C.> | | | | | 57 | 59 | 46 | 41 | 57 | 47 | 49 | 41 | 52 |
| Water absorption rate (%) | | | | | 5.6 | 6.1 | 7.2 | 6.3 | 8.1 | 11.4 | 5.2 | 4.2 | 8.3 |
| | | | | | Comparative Examples | | | | | | | | |
| Component proportions (parts by weight) | | | | | 1 | 2 | 3 | 4 | 5 | 6 | 7 | | |
| (A) | Epoxy resin | | A-1 | | 40 | 40 | 40 | 40 | 40 | 40 | 40 | | |
| (A) + (B) | Dispersion (M) containing polymer | | | | 100 | 100 | 100 | 100 | 100 | 100 | 100 | | |
| | particles (B) dispersed in (A) | | M-1 | | | | | | | | | | |
| (C) | Phenolic compound | 4-tert- | 1^{(*)} | 0^{(**)} | | 15.9 | 23.8 | | | | | | |
| | | Butylphenol | | | | | | | | | | | |
| | | Bisphenol A | 2^{(*)} | 0/0^{(**)} | | | | 60.4 | | | | | |
| | | Bisphenol M | 2^{(*)} | 0/0^{(**)} | | | | | | | | | |
| | Non-phenolic | Anisole | 0^{(*)} | 0^{(**)} | | | | | 5.7 | | | | |
| | compound | | | | | | | | | | | | |

| | | | | | | | | | |
|---|---|---|---|---|---|---|---|---|---|
| (D) | Dicyandiamide | Dyhard 100S | 11.1 | 11.1 | 11.1 | 11.1 | 11.1 | 7 | 14 |
| (F) | Curing accelerator | Dyhard UR200 | 1 | 1 | 1 | 1 | 1 | 1 | 1 |

| | | | | | | | |
|---|---|---|---|---|---|---|---|
| Amount of component (B) per 100 parts of component (A) | 40 | 40 | 40 | 40 | 40 | 40 | 40 |
| Amount of component (C) per 100 parts of component (A) | 0 | 16 | 24 | 60 | 0 | 0 | 0 |
| Amount of component (D) per 100 parts of component (A) | 11 | 11 | 11 | 11 | 11 | 7 | 14 |
| Amount of component(F) per 100 parts of component (A) | 1 | 1 | 1 | 1 | 1 | 1 | 1 |
| Ratio of number of moles of phenolic OH groups of component (C) to | 0.00 | 0.40 | 0.60 | 2.00 | 0.00 | 0.00 | 0.00 |
| number of moles of CN groups derived from component (D) | | | | | | | |
| Ratio of molar amount of component (D) to molar amount of epoxy groups | 0.25 | 0.25 | 0.25 | 0.25 | 0.25 | 0.16 | 0.31 |
| of component (A) | | | | | | | |
| Dynamic cleavage resistance (kN/m) <23° C.> | 36 | 2 | 1 | 3 | 31 | 26 | 43 |
| Water absorption rate (%) | 5.5 | 8.8 | 19.3 | 10.1 | 4.3 | | 6.4 |

^{(*)}Number of phenolic hydroxy groups per molecule
^{(**)}Number of tertiary alkyl groups attached at ortho positions relative to each phenolic hydroxy group

Table 1 reveals that when the one-part curable resin compositions of Examples 1 to 9 which contained the components (A) to (D) were cured, the resulting cured products had good impact peel performance.

In contrast, the compositions of Comparative Examples 1, 6, and 7 did not contain the phenolic compound (C), and the impact peel performance was lower in each of these comparative examples than in Example 1, 8, or 9 where the types and proportions of the components other than the component (C) were the same as those in the comparative example.

The compositions of Comparative Examples 2 to 4 were ones in which the ratio of the number of moles of the phenolic hydroxy groups of the compound (C) to the number of moles of CN groups derived from the dicyandiamide (D) was large, namely in which the amount of the compound (C) was relatively large. In these comparative examples, the impact peel performance was extremely low.

The composition of Comparative Example 5 was one which contained, instead of the phenolic compound (C), anisole which is an aromatic compound having no phenolic hydroxy groups, and the impact peel performance was lower in this comparative example than in Examples 1 to 9.

| | | | | | Examples | | | | | | | | |
|---|---|---|---|---|---|---|---|---|---|---|---|---|---|
| Component proportions (parts by weight) | | | | | 10 | 11 | 12 | 13 | 14 | 15 | 16 | 17 | 18 |
| (A) | Epoxy resin | | A-1 | | 55 | 55 | 55 | 55 | 55 | 55 | 55 | 55 | 55 |
| (A) + (B) | Dispersion (M) containing polymer particles (B) dispersed in (A) | | M-1 | | 75 | 75 | 75 | 75 | 75 | 75 | 75 | 75 | 75 |
| (C) | | Phenol | 1^{(*)} | 0^{(**)} | 3.1 | | | | | | | | |
| | | 4-Methoxphenol | 1^{(*)} | 0^{(**)} | | 4.1 | | | | | | | |
| | | 2,6-Xylenol | 1^{(*)} | 0^{(**)} | | | 4.1 | | | | | | |
| | Phenolic compound | Resorcinol | 2^{(*)} | 0/0^{(**)} | | | | 3.7 | | | | | |
| | | Catechol | 2^{(*)} | 0/0^{(**)} | | | | | 3.7 | | | | |
| | | 4-tert -Butylcatechol | 2^{(*)} | 0/0^{(**)} | | | | | | 5.5 | 11.1 | | |
| | | Bisphenol A | 2^{(*)} | 0/0^{(**)} | | | | | | | | 7.6 | |
| | | Hydroquinone | 2^{(*)} | 0/0^{(**)} | | | | | | | | | 3.7 |
| (D) | Dicyandiamide | Dyhard 100S | | | 7 | 7 | 7 | 7 | 7 | 7 | 7 | 7 | 7 |
| (F) | Curing accelerator | Dyhard UR200 | | | 1 | 1 | 1 | 1 | 1 | 1 | 1 | 1 | 1 |
| | Fumed silica | TS 720 | | | 3 | 3 | 3 | 3 | 3 | 3 | 3 | 3 | 3 |
| | Calcium carbonate | WHIT ON SB | | | 100 | 100 | 100 | 100 | 100 | 100 | 100 | 100 | 100 |
| | Carbon black | MONARCH 280 | | | 0.3 | 0.3 | 0.3 | 0.3 | 0.3 | 0.3 | 0.3 | 0.3 | 0.3 |
| | Calcium oxide | CML #31 | | | 1.5 | 1.5 | 1.5 | 1.5 | 1.5 | 1.5 | 1.5 | 1.5 | 1.5 |
| Amount of component (B) per 100 parts of component (A) | | | | | 30 | 30 | 30 | 30 | 30 | 30 | 30 | 30 | 30 |
| Amount of component (C) per 100 parts of component (A) | | | | | 3 | 4 | 4 | 4 | 4 | 6 | 11 | 8 | 4 |
| Amount of component (D) per 100 parts of component (A) | | | | | 7 | 7 | 7 | 7 | 7 | 7 | 7 | 7 | 7 |
| Amount of component (F) per 100 parts of component (A) | | | | | 1 | 1 | 1 | 1 | 1 | 1 | 1 | 1 | 1 |
| Ratio of number of moles of phenolic OH groups of component (C) to number of moles of CN groups derived from component (D) | | | | | 0.20 | 0.20 | 0.20 | 0.40 | 0.40 | 0.40 | 0.80 | 0.40 | 0.40 |
| T-peel bond strength (N/25 mm) <23° C..> | | | | | 252 | 246 | 250 | 260 | 261 | 265 | 290 | 259 | 247 |
| Dynamic cleavage resistance (kN/m) <23° C..> | | | | | 27 | 27 | 26 | 29 | 33 | 33 | 42 | 32 | 33 |
| Viscosity increase rate (viscosity after storage/viscosity before storage) | | | | | — | — | — | — | — | — | — | 2.8 | 2.5 |

| | | | | | Examples | | | | Comparative Examples | | |
|---|---|---|---|---|---|---|---|---|---|---|---|
| Component proportions (parts by weight) | | | | | 19 | 20 | 21 | 22 | 8 | 9 | 10 |
| (A) | Epoxy resin | | A-1 | | 55 | 55 | 55 | 55 | 55 | 55 | 55 |
| (A) + (B) | Dispersion (M) containing polymer particles (B) dispersed in (A) | | M-1 | | 75 | 75 | 75 | 75 | 75 | 75 | 75 |
| (C) | Phenolic compound | Methylhydroquinone | 2^{(*)} | 0/0^{(**)} | 4.1 | | | | | | |
| | | tert-Butylhydroquinone | 2^{(*)} | 1/0^{(**)} | | 5.5 | | | | | |
| | | 2,5-Di-tert-butylhydroquinone | 2^{(*)} | 1/1^{(**)} | | | 7.4 | | | | |
| | | 2,2'-Diallylbisphenol A | 2^{(*)} | 0/0^{(**)} | | | | 10.3 | | | |
| | Phenolic compound not | 2,4,6-Tris(dimethylamino | 1^{(*)} | 0^{(**)} | | | | | | 8.8 | 3.5 |
| | classifiable | methyl) phenol | | | | | | | | | |
| | as component (C) | Novolac phenolic resin, TD-2090 | 4 or more^{(*)} | — | | | | | | | |

| | | | | | | | | | |
|---|---|---|---|---|---|---|---|---|---|
| (D) | Dicy andiamide | Dyhard 100S | 7 | 7 | 7 | 7 | 7 | 7 | 7 |
| (F) | Curing accelerator | Dyhard UR200 | 1 | 1 | 1 | 1 | 1 | 1 | 1 |
| | Fumed silica | TS-720 | 3 | 3 | 3 | 3 | 3 | 3 | 3 |
| | Calcium carbonate | WHITON SB | 100 | 100 | 100 | 100 | 100 | 100 | 100 |
| | Carbon black | MONARCH 280 | 0.3 | 0.3 | 0.3 | 0.3 | 0.3 | 0.3 | 0.3 |
| | Calcium oxide | CML #31 | 1.5 | 1.5 | 1.5 | 1.5 | 1.5 | 1.5 | 1.5 |

| | | | | | | | |
|---|---|---|---|---|---|---|---|
| Amount of component (B) per 100 parts of component (A) | 30 | 30 | 30 | 30 | 30 | 30 | 30 |
| Amount of component (C) per 100 parts of component (A) | 4 | 6 | 7 | 10 | 0 | 0 | 0 |
| Amount of component (D) per 100 parts of component (A) | 7 | 7 | 7 | 7 | 7 | 7 | 7 |
| Amount of component (F) per 100 parts of component (A) | 1 | 1 | 1 | 1 | 1 | 1 | 1 |
| Ratio of number of moles of phenolic OH groups of component (C) to number of moles of CN groups derived from component (D) | 0.40 | 0.40 | 0.40 | 0.40 | 0.00 | 0.20 | 0.20 |
| T-peel bond strength (N/25 mm) <23° C..> | 261 | 259 | 253 | 267 | 220 | (***) | 220 |
| Dynamic cleavage resistance (kN/m) <23º C.> | 33 | 32 | 30 | 32 | 22 | (***) | 18 |
| Viscosity increase rate (viscosity after storage/viscosity before storage) | 2 | 1.9 | 1 | | 0.9 | | |

^{(*)}Number of phenolic hydroxy groups per molecule
^{(**)}Number of tertiary alkyl groups attached at ortho positions relative to each phenolic hydroxy group
(***)Curable resin composition gelled within 1 hour after preparation. Evaluation was impossible.

Table 2 reveals that in Examples 10 to 22 where the one-part curable resin compositions contained the phenolic compound (C), the impact peel performance was better and the T-peel bond strength was higher than in Comparative Example 8 where the composition did not contain the component (C).

In Comparative Example 9 or 10, the composition contained a phenolic compound which does not meet the definition of the component (C). In Comparative Example 10, the value of the impact peel performance was smaller than in Comparative Example 8, and the value of the T-peel bond strength was equal to that in Comparative Example 8. In Comparative Example 9, the one-part curable resin composition gelled within 1 hour after preparation of the composition, and any sample for evaluation was not able to be made. This demonstrates that a phenolic compound having an amino group reduces the stability of a composition and impairs the storage stability that the composition should have when used as a one-part curable resin composition.

As to Examples 17 to 21, it is seen that the viscosity increase rate after 14-day storage at 40° C. was low in Examples 19 to 21, in particular Example 21, and therefore that the one-part curable resin compositions of Examples 19 to 21, in particular the composition of Example 21, had relatively good storage stability. This is presumably due to the presence and number of substituents on the aromatic ring of the phenolic compound (C).

| | | | | | Examples | | | | | | Comparative Examples | |
|---|---|---|---|---|---|---|---|---|---|---|---|---|
| Component proportions (parts by weight) | | | | | 23 | 24 | 25 | 26 | 27 | 28 | 11 | 12 |
| (A) | | | A-1 | | 55 | 55 | 55 | 55 | 55 | 100 | 100 | 100 |
| (A) + (B) | | | M-1 | 0.5^{(***)} | 75 | | | | | | | |
| | | | M-2 | 2.2^{(***)} | | 75 | | | | | | |
| | Epoxy resin | | M-3 | 1.1^{(***)} | | | 75 | | | | | |
| | Dispersion (M) containing polymer | | M-4 | 0.5^{(***)} | | | | 75 | | | | |
| | particles (B) dispersed in (A) | | M-5 | 0^{(***)} | | | | | 75 | | | |
| (B) | Blocked urethane | | B-1 | | | | | | | 30 | | 30 |
| (C) | Phenolic compound | 2,5-Di-tert-butyl | 2^{(*)} | 1/1^{(**)} | 7.4 | 7.4 | 7.4 | 7.4 | 7.4 | 7.4 | 7.4 | |
| | | hydroquinone | | | | | | | | | | |

| | | | | | | | | | | |
|---|---|---|---|---|---|---|---|---|---|---|
| (D) | Dicy andiamide | Dyhard 100S | 7 | 7 | 7 | 7 | 7 | 7 | 7 | 7 |
| (F) | Curing accelerator | Dyhard UR200 | 1 | 1 | 1 | 1 | 1 | 1 | 1 | 1 |
| | Fumed silica | TS-720 | 3 | 3 | 3 | 3 | 3 | 3 | 3 | 3 |
| | Calcium carbonate | WHITON SB | 100 | 100 | 100 | 100 | 100 | 100 | 100 | 100 |
| | Carbon black | MONARCH 280 | 0.3 | 0.3 | 0.3 | 0.3 | 0.3 | 0.3 | 0.3 | 0.3 |
| | Calcium oxide | CML #31 | 1.5 | 1.5 | 1.5 | 1.5 | 1.5 | 1.5 | 1.5 | 1. |

| | | | | | | | | |
|---|---|---|---|---|---|---|---|---|
| Amount of component (B) per 100 parts of component (A) | 30 | 30 | 30 | 30 | 30 | 30 | 0 | 30 |
| Amount of component (C) per 100 parts of component (A) | 7 | 7 | 7 | 7 | 7 | 7 | 7 | 0 |
| Amount of component (D) per 100 parts of component (A) | 7 | 7 | 7 | 7 | 7 | 7 | 7 | 7 |
| Amount of component (F) per 100 parts of component (A) | 1 | 1 | 1 | 1 | 1 | 1 | 1 | 1 |

| | | | | | | | | |
|---|---|---|---|---|---|---|---|---|
| Ratio of number of moles of phenolic OH groups of component (C) to | 0.40 | 0.40 | 0.40 | 0.40 | 0.40 | 0.40 | 0.40 | 0.00 |
| number of moles of CN groups derived from component (D) | | | | | | | | |
| Dynamic cleavage resistance (kN/m) <23° C..> | 28 | 20 | 27 | 29 | 23 | 17 | 1 | 14 |

^{(*)}Number of phenolic hydroxy groups per molecule
^{(**)}Number of tertiary alkyl groups attached at ortho positions relative to each phenolic hydroxy group
^{(***)}Amount of epoxy groups of shell layer of polymer particle (B) based on total amount of shell layer, (mmol/g)

Table 3 reveals that in Examples 23 to 28 where the one-part curable resin compositions contained the phenolic compound (C), the impact peel performance was better than in Comparative Example 12 where the composition did not contain the component (C). In Comparative Example 11 where the composition did not contain the component (B), the impact peel performance was extremely low. The above results demonstrate that the enhancing effect on the impact peel performance is a synergistic effect achieved by the combined use of the components (B) and (C).

| | | | | | Examples | | | | | | Comparative Examples | | | | |
|---|---|---|---|---|---|---|---|---|---|---|---|---|---|---|---|
| Component proportions (parts by weight) | | | | | 29 | 30 | 31 | 32 | 33 | 34 | 13 | 14 | 15 | 16 | 17 |
| (A) | Epoxy resin | Bisphenol A epoxy resin | A-1 | | 55 | 55 | 55 | 55 | 41.5 | 35.7 | 55 | 55 | 55 | 41.5 | 35.7 |
| | | Elastomer-modified epoxy | A-2 | | | | | | 25 | | | | | 25 | |
| | | resin | | | | | | | | | | | | | |
| | | Urethane-modified epoxy | A-3 | | | | | | | 25 | | | | | 25 |
| | | resin | | | | | | | | | | | | | |
| (A) + (B) | Dispersion (M ) containing polymer | | M-1 | | 75 | 75 | 75 | 75 | 75 | 75 | 75 | 75 | 75 | 75 | 75 |
| | particles (B) dispersed in (A) | | | | | | | | | | | | | | |
| (B) | Blocked urethane | | B-1 | | | 10 | 15 | | | | | 10 | 15 | | |
| | Rubber polymer | CTBN 1300 × 8 | | | | | | 5 | | | | | | | |
| (C) | Phenolic | 2,5-Di-tert-butylhydro | 2^{(*)} | 1/1^{(**)} | 7.4 | 7.4 | 4.2 | 7.4 | 7.4 | 7.4 | | | | | |
| | compound | quinone Pyrogallol | 3^{(*)} | 0/0/0^{(**)} | | | | | | | | | | | |

| | | | | | | | | | | | | | |
|---|---|---|---|---|---|---|---|---|---|---|---|---|---|
| (D) | Dicy andiamide | Dyhard 100S | 7 | 7 | 7 | 7 | 7 | 7 | 7 | 7 | 7 | 7 | 7 |
| (F) | Curing accelerator | Dyhard UR200 | 1 | 1 | 1.5 | 1 | 1 | 1 | 1 | 1 | 1.5 | 1 | 1 |
| | Fumed silica | TS-720 | 3 | 3 | 3 | 3 | 3 | 3 | 3 | 3 | 3 | 3 | 3 |
| | Calcium carbonate | WHITON SB | 60 | 60 | 100 | 60 | 60 | 60 | 60 | 60 | 100 | 60 | 60 |
| | Carbon black | MONARCH 280 | 0. | 0.3 | 0.3 | 0.3 | 0.3 | 0.3 | 0.3 | 0.3 | 0.3 | 0.3 | 0.3 |
| | Calcium oxide | CML #31 | 1.5 | 1.5 | 1.5 | 1.5 | 1.5 | 1.5 | 1.5 | 1.5 | 1.5 | 1.5 | 1.5 |

| | | | | | | | | | | | |
|---|---|---|---|---|---|---|---|---|---|---|---|
| Amount of component (B) per 100 parts of component (A) | 30 | 40 | 45 | 30 | 27 | 28 | 30 | 40 | 45 | 27 | 28 |
| Amount of component (C) per 100 parts of component (A) | 7 | 7 | 4 | 7 | 7 | 7 | 0 | 0 | 0 | 0 | 0 |
| Amount of component (D) per 100 parts of component (A) | 7 | 7 | 7 | 7 | 6 | 7 | 7 | 7 | 7 | 6 | 7 |
| Amount of component (F) per 100 parts of component (A) | 1 | 1 | 2 | 1 | 1 | 1 | 1 | 1 | 2 | 1 | 1 |

| | | | | | | | | | | | |
|---|---|---|---|---|---|---|---|---|---|---|---|
| Ratio of number of moles of phenolic OH groups of component (C) to | 0.40 | 0.40 | 0.60 | 0.40 | 0.40 | 0.40 | 0.00 | 0.00 | 0.00 | 0.00 | 0.00 |
| number of moles of CN groups derived from component (D) | | | | | | | | | | | |
| T-peel bond strength (N/25mm) <23° C.> | 238 | 292 | 256 | 299 | 313 | 281 | 197 | 269 | 237 | 260 | 243 |
| Dynamic cleavage resistance (KN/m) <23º° C..> | 41 | 38 | 36 | 38 | 40 | 34 | 24 | 32 | 27 | 27 | 25 |

^{(*)}Number of phenolic hydroxy groups per molecule
^{(**)}Number of tertiary alkyl groups attached at ortho positions relative to each phenolic hydroxy group
^{(***)}Amount of epoxy groups of shell layer of polymer particle (B) based on total amount of shell layer, (mmol/g)

Table 4 reveals that in Example 29 where the composition contained the phenolic compound (C), the impact peel performance was better and the T-peel bond strength was higher than in Comparative Example 13 where the composition did not contain the phenolic compound (C) and where the types and proportions of the components other than the component (C) were the same as those in Example 29. It is also seen that Example 30 exhibited better impact peel performance and higher T-peel bond strength than Comparative Example 14, Example 31 exhibited better impact peel performance and higher T-peel bond strength than Comparative Example 15, Example 33 exhibited better impact peel performance and higher T-peel bond strength than Comparative Example 16, and Example 34 exhibited better impact peel performance and higher T-peel bond strength than Comparative Example 17.

It is also seen that in Example 32 where a rubber polymer was added, the T-peel bond strength was higher than in Example 29 where the types and proportions of the components other than the rubber polymer were the same as those in Example 32.

| | | | | | | | | | | Comparative |
|---|---|---|---|---|---|---|---|---|---|---|
| | | | | | Examples | | | | | Example |
| Component proportions (parts by weight) | | | | | 35 | 36 | 37 | 38 | 39 | 18 |
| (A) | Epoxy resin | | A-1 | | 55 | 55 | 55 | 55 | 55 | 55 |
| (A) + (B) | Dispersion (M) containing poly mer particles (B) | | M-2 | | 75 | 75 | 75 | 75 | 75 | 75 |
| (B) | dispersed in (A) Blocked urethane | | B-1 | | 10 | 10 | 10 | 10 | 10 | 10 |
| (C) | Phenolic compound | Phenol | 1^{(*)} | 0^{(*)} | 3.1 | | | | | |
| | | 4-Methoxphenol | 1^{(*)} | 0^{(*)} | | 4.1 | | | | |
| | | Catechol | 2^{(*)} | 0/0^{(**)} | | | 3.7 | | | |
| | | 4-tert-Butylcatechol | 2^{(*)} | 0/0)^{(*)} | | | | 5.5 | | |
| | | Bisphenol A | 2^{(*)} | 0/0^{(*)} | | | | | 7.6 | |

| | | | | | | | | |
|---|---|---|---|---|---|---|---|---|
| (D) | Dicy andiamide | Dyhard 100S | 7 | 7 | 7 | 7 | 7 | 7 |
| (F) | Curing accelerator | Dyhard UR300 | 1 | 1 | 1 | 1 | 1 | 1 |
| | Fumed silica | TS-720 | 3 | 3 | 3 | 3 | 3 | 3 |
| | Calcium carbonate | WHITON SB | 60 | 60 | 60 | 60 | 60 | 60 |
| | Carbon black | MONARCH 280 | 0.3 | 0.3 | 0.3 | 0.3 | 0.3 | 0.3 |
| | Calcium oxide | CML #31 | 1.5 | 1.5 | 1.5 | 1.5 | 1.5 | 1.5 |

| | | | | | | |
|---|---|---|---|---|---|---|
| Amount of component (B) per 100 parts of component (A) | 40 | 40 | 40 | 40 | 40 | 40 |
| Amount of component (C) per 100 parts of component (A) | 3 | 4 | 4 | 0 6 | 8 | 0 |
| Amount of component (D) per 100 parts of component (A) | 7 | 7 | 7 | 7 | 7 | 7 |
| Amount of component (F) per 100 parts of component (A) | 1 | 1 | 1 | 1 | 1 | 1 |

| | | | | | | |
|---|---|---|---|---|---|---|
| Ratio of number of moles of phenolic OH groups of component (C) to number | 0.20 | 0.20 | 0.40 | 0.40 | 0.40 | 0.00 |
| of moles of CN groups derived from component (D) | | | | | | |
| T-peel bond strength (N/25mm) <23° C.> | 245 | 256 | 226 | 222 | 224 | 201 |
| Dynamic cleavage resistance (KN/m) <23º C.> | 36 | 36 | 44 | 42 | 41 | 30 |

Table 5 reveals that in Examples 35 to 39 where the one-part curable resin compositions contained the phenolic compound (C), the impact peel performance was better and the T-peel bond strength was higher than in Comparative Example 18 where the composition did not contain the component (C).

| | | | | | Examples | | | | | |
|---|---|---|---|---|---|---|---|---|---|---|
| Component proportions (parts by weight) | | | | | 40 | 41 | 42 | 43 | 44 | 45 |
| (A) | Epoxy resin | | A-1 | | 55 | 55 | 55 | 55 | 55 | 55 |
| (A) + (B) | Dispersion (M) containing polymer | | M-1 | | 75 | 75 | 75 | 75 | 75 | 75 |
| | particles (B) dispersed in (A) | | | | | | | | | |
| | Rubber polymer | CTBN 1300 × 8 | | | 5 | 5 | 5 | 5 | 5 | 5 |
| (C) | Phenolic compound | 4-Methoxphenol | 1^{(*)} | 0^{(**)} | 4.1 | | | | | |
| | | 2,6-Xylenol | 1^{(*)} | 0^{(**)} | | 4.1 | | | | |
| | | Catechol | 2^{(*)} | 0/0^{(**)} | | | 3.7 | | | |
| | | 4-tert-Butylcatechol | 2^{(*)} | 0/0^{(**)} | | | | 5.5 | | |
| | | Hydroquinone | 2^{(*)} | 0/0^{(**)} | | | | | 3.7 | |
| | | Methylhydroquinone | 2^{(*)} | 0/0^{(**)} | | | | | | 4.1 |
| | | tert-Butylhydroquin one | 2^{(*)} | 1/0^{(**)} | | | | | | |
| | | 2,5-Di-tert-butylhydroquinone | 2^{(*)} | 1/1^{(**)} | | | | | | |
| | | Bisphenol A | 2^{(*)} | 0/0^{(**)} | | | | | | |
| | | 2,2* - Dially 1 bisphenol A | 2^{(*)} | 0/0^{(**)} | | | | | | |
| (D) | Dicyandiamide | Dyhard 100S | | | 7 | 7 | 7 | 7 | 7 | 7 |
| (F) | Curing accelerator | Dyhard UR200 | | | 3 | 3 | 3 | 3 | 3 | 3 |
| | Fumed silica | TS- 720 | | | 3 | 3 | 3 | 3 | 3 | 3 |
| | Calcium carbonate | Vigot-10 | | | 60 | 60 | 60 | 60 | 60 | 60 |
| | Carbon black | MONARCH 280 | | | 0.3 | 0.3 | 0.3 | 0.3 | 0.3 | 0.3 |
| | Calcium oxide | CML #31 | | | 1.5 | 1.5 | 1.5 | 1.5 | 1.5 | 1.5 |
| | Amount of component (B) per 100 parts of component (A) | | | | 30 | 30 | 30 | 30 | 30 | 30 |
| | Amount of component (C) per 100 parts of component (A) | | | | 4 | 4 | 4 | 6 | 4 | 4 |
| | Amount of component (D) per 100 parts of component (A) | | | | 7 | 7 | 7 | 7 | 7 | 7 |
| | Amount of component (F) per 100 parts of component (A) | | | | 3 | 3 | 3 | 3 | 3 | 3 |
| Ratio of number of moles of phenolic OH groups of component (C) to | | | | | 0.20 | 0.20 | 1.40 | 0.40 | 0.40 | 0.40 |
| number of moles of CN groups derived from component (D) | | | | | | | | | | |
| T-peel bond strength (before moist heat exposure test) (N/25 mm) <23° C.> | | | | | 187 | 193 | 184 | 183 | 189 | 232 |
| T-peel bond strength retention rate after moist heat exposure test | | | | | 0.49 | 0.94 | 0.52 | 0.63 | 0.5 | 0.6 |
| (strength after test/strength before test) | | | | | | | | | | |
| Dynamic cleavage resistance (kN/m) <23° C.> | | | | | 21 | 21 | 29 | 27 | 27 | 28 |
| | | | | | | | | | Comparative | |
| | | | | | Examples | | | | Example | |
| Component proportions (parts by weight) | | | | | 46 | 47 | 48 | 49 | 19 | |
| (A) | Epoxy resin | | A-1 | | 55 | 55 | 55 | 55 | 55 | |
| (A) + (B) | Dispersion (M) containing polymer | | M-1 | | 75 | 75 | 75 | 75 | 75 | |
| | particles (B) dispersed in (A) | | | | | | | | | |
| | Rubber polymer | CTBN 1300 × 8 | | | 5 | 5 | 5 | 5 | 5 | |
| (C) | Phenolic compound | 4-Methoxphenol | 1^{(*)} | 0^{(**)} | | | | | | |
| | | 2,6-Xylenol | 1^{(*)} | 0^{(**)} | | 4.1 | | | | |
| | | Catechol | 2^{(*)} | 0/0^{(**)} | | | 3.7 | | | |
| | | 4-tert-Butylcatechol | 2^{(*)} | 0/0^{(**)} | | | | 5.5 | | |
| | | Hydroquinone | 2^{(*)} | 0/0^{(**)} | | | | | 3.7 | |
| | | Methylhydroquinone | 2^{(*)} | 0/0^{(**)} | | | | | | |
| | | tert-Butylhydroquin one | 2^{(*)} | 1/0^{(**)} | | | | | | |
| | | 2,5-Di-tert-butylhydroquinone | 2^{(*)} | 1/1^{(**)} | | | | | | |
| | | Bisphenol A | 2^{(*)} | 0/0^{(**)} | | | | | | |
| | | 2,2* - Dially 1 bisphenol A | 2^{(*)} | 0/0^{(**)} | | | | | | |

| | | | | | | | |
|---|---|---|---|---|---|---|---|
| (D) | Dicyandiamide | Dyhard 100S | 7 | 7 | 7 | 7 | 7 |
| (F) | Curing accelerator | Dyhard UR200 | 3 | 3 | 3 | 3 | 3 |
| | Fumed silica | TS- 720 | 3 | 3 | 3 | 3 | 3 |
| | Calcium carbonate | Vigot-10 | 60 | 60 | 60 | 60 | 60 |
| | Carbon black | MONARCH 280 | 0.3 | 0.3 | 0.3 | 0.3 | 0.3 |
| | Calcium oxide | CML #31 | 1.5 | 1.5 | 1.5 | 1.5 | 1.5 |

| | | | | | |
|---|---|---|---|---|---|
| Amount of component (B) per 100 parts of component (A) | 30 | 30 | 30 | 30 | 30 |
| Amount of component (C) per 100 parts of component (A) | 7 | 8 | 10 | 0 | 4 |
| Amount of component (D) per 100 parts of component (A) | 7 | 7 | 7 | 7 | 7 |
| Amount of component (F) per 100 parts of component (A) | 3 | 3 | 3 | 3 | 3 |

| | | | | | |
|---|---|---|---|---|---|
| Ratio of number of moles of phenolic OH groups of component (C) to | 0.40 | 0.40 | 0.40 | 0.40 | 0.00 |
| number of moles of CN groups derived from component (D) | | | | | |
| T-peel bond strength (before moist heat exposure test) (N/25 mm) <23° C.> | 223 | 211 | 228 | 247 | 162 |
| T-peel bond strength retention rate after moist heat exposure test | 0.8 | 0.77 | 0.59 | 0.72 | 0.54 |
| (strength after test/strength before test) | | | | | |
| Dynamic cleavage resistance (kN/m) <23° C.> | 29 | 27 | 30 | 34 | 20 |

Table 6 reveals that in Examples 40 to 49 where the one-part curable resin compositions contained the phenolic compound (C), the impact peel performance was better and the T-peel bond strength was higher than in Comparative Example 19 where the composition did not contain the component (C).

As to Examples 40 to 49, it is seen that the T-peel bond strength retention rate after moisture heat exposure test was high in Examples 41, 46, 47, and 49 and therefore that the cured products obtained in these examples had high moist heat resistance. This demonstrates that it is preferable for the phenolic compound (C) to have substituents at ortho positions relative to the phenolic hydroxy groups in terms of improving the moist heat resistance.

| | | | | | | | | | Comparative |
|---|---|---|---|---|---|---|---|---|---|
| | | | | | Examples | | | | Example |
| Component proportions (parts by weight) | | | | | 50 | 51 | 52 | 53 | 20 |
| (A) | Epoxy resin | | A-1 | | 55 | 55 | 55 | 55 | 55 |
| (A) + (B) | Dispersion (M) containing polymer | | M-2 | | 75 | 75 | 75 | 75 | 75 |
| | particles (B) dispersed in (A) | | | | | | | | |
| (B) | Blocked urethane | | B-1 | | 10 | 10 | 10 | 10 | 10 |
| (C) | Phenolic compound | 3-Methyl-6-tert-butylphenol | 1^{(*)} | 1^{(**)} | 5.5 | | | | |
| | | 2-Methyl-6-tert-butylphenol | 1^{(*)} | 1^{(**)} | | 5.5 | | | |
| | | 2,5-Di-tert-butylhydroquinone | 2^{(*)} | 1/1^{(*)} | | | 7.4 | 19.6 | |
| | | [Ethylenebis(oxyethy lene)] | 2^{(*)} | 1/1^{(**)} | | | | | |
| | | bis[3-(3-tert-butyl-4-hydroxy-5- | | | | | | | |
| | | methylphenyl)propionate)] | | | | | | | |

| | | | | | | | |
|---|---|---|---|---|---|---|---|
| (D) | Dicy andiamide | Dyhard 100S | 7 | 7 | 7 | 7 | 7 |
| (F) | Curing accelerator | Dyhard UR200 | 2 | 2 | 2 | 2 | 2 |
| | Fumed silica | TS-720 | 6 | 6 | 6 | 6 | 6 |
| | Calcium carbonate | WHITON SB | 60 | 60 | 60 | 60 | 60 |
| | Carbon black | MONARCH 280 | 0.3 | 0.3 | 0.3 | 0.3 | 0.3 |
| | Calcium oxide | CML #31 | 1.5 | 1.5 | 1.5 | 1.5 | 1.5 |

| | | | | | |
|---|---|---|---|---|---|
| Amount of component (B) per 100 parts of component (A) | 40 | 40 | 40 | 40 | 40 |
| Amount of component (C) per 100 parts of component (A) | 5 | 5 | 7 | 20 | O |
| Amount of component (D) per 100 parts of component (A) | 7 | 7 | 7 | 7 | 7 |
| Amount of component (F) per 100 parts of component (A) | 2 | 2 | 2 | 2 | 2 |

| | | | | | |
|---|---|---|---|---|---|
| Ratio of number of moles of phenolic OH groups of component (C) to number of | 0.20 | 0.20 | 0.40 | 0.40 | 0.00 |
| moles of CN groups derived from component (D) | | | | | |
| Dynamic cleavage resistance (KN/m) <23° C.> | 31 | 30 | 31 | 28 | 27 |
| Viscosity increase rate (viscosity after storage/viscosity before storage) | 2 | 1.2 | 2.4 | 1.3 | 0.9 |

Table 7 reveals that in Examples 50 to 53 where the one-part curable resin compositions contained the phenolic compound (C), the impact peel performance was higher than in Comparative Example 20 where the composition did not contain the component (C).

It is also seen that for the one-part curable resin compositions of Examples 50 to 53, the viscosity increase rate after 14-day storage at 40° C. was low and therefore that these compositions had relatively good storage stability. This is presumably due to the fact that the phenolic compound (C) used had one tertiary alkyl group at an ortho position relative to each phenolic hydroxy group.

As to Examples 50 to 53, it is seen that the one-part curable resin compositions of Examples 51 and 53 showed a particularly low viscosity increase rate and therefore that the two compositions had high storage stability. This is presumably due to the fact that the phenolic compound (C) used had a methyl group and a tertiary alkyl group at ortho positions relative to each phenolic hydroxy group.

| | | | | | | | | Comparative | | |
|---|---|---|---|---|---|---|---|---|---|---|
| | | | | | Examples | | | Examples | | |
| Component proportions (parts by weight) | | | | | 54 | 55 | 56 | 21 | 22 | 23 |
| (A) | Epoxy resin | | A-1 | | 55 | 55 | 55 | 55 | 55 | 55 |
| (A) + (B) | Dispersion (M ) containing polymer | | M-2 | | 75 | 75 | 75 | 75 | 75 | 75 |
| | particles (B) dispersed in (A) | | | | | | | | | |
| (B) | Blocked urethane | | B-1 | | 10 | 10 | 10 | | 10 | 10 |
| | Rubber polymer | CTBN 1300 × 8 | | | 5 | 5 | 5 | | | 5 |
| (C) | Phenolic compound | 2-Methyl-6-tert-butylphenol | 1^{(*)} | 1^{(**)} | 5.5 | 5.9 | 9.8 | | | |
| | | 6-tert-Butyl-2,4-Xylenol | 1^{(*)} | 1^{(**)} | | | | | | |
| | | [Ethylenebis(oxyethylene)] bis[3- | 2^{(*)} | 1/1^{(**)} | | | | | | |
| | | (3-tert-butyl-4-hydroxy-5- | | | | | | | | |
| | | methylphenyl)propionate)] | | | | | | | | |

| | | | | | | | | |
|---|---|---|---|---|---|---|---|---|
| (D) | Dicy andiamide | Dyhard 100S | 7 | 7 | 7 | 7 | 7 | 7 |
| (F) | Curing accelerator | Dyhard UR200 | 4 | 4 | 4 | 4 | 4 | 4 |
| | Fumed silica | TS-720 | 6 | 6 | 6 | 6 | 6 | 6 |
| | Calcium carbonate | WHITON SB | 60 | 60 | 60 | 60 | 60 | 60 |
| | Carbon black | MONARCH 280 | 0.3 | 0.3 | 0.3 | 0.3 | 0.3 | 0.3 |
| | Calcium oxide | CML #31 | 1.5 | 1.5 | 1.5 | 1.5 | 1.5 | 1.5 |

| | | | | | | |
|---|---|---|---|---|---|---|
| Amount of component (B) per 100 parts of component (A) | 40 | 40 | 40 | 30 | 40 | 40 |
| Amount of component (C) per 100 parts of component (A) | 5 | 6 | 10 | 0 | 0 | 0 |
| Amount of component (D) per 100 parts of component (A) | 7 | 7 | 7 | 7 | 7 | 7 |
| Amount of component (F) per 100 parts of component (A) | 4 | 4 | 4 | 4 | 4 | 4 |

| | | | | | | |
|---|---|---|---|---|---|---|
| Ratio of number of moles of phenolic OH groups of component (C) to number of moles | 0.20 | 0.20 | 0.20 | 0.00 | 0.00 | 0.00 |
| of CN groups derived from component (D) | | | | | | |
| T-peel bond strength (N/25mm) <23° C.> | 216 | 226 | 244 | 163 | 208 | 207 |
| Dynamic cleavage resistance (kN/m) <23° C.> | 33 | 32 | 37 | 19 | 27 | 31 |
| Dynamic cleavage resistance retention rate after moist heat exposure test | 0.83 | 0.87 | 0.77 | 0.58 | 0.48 | 0.74 |
| (strength after test/strength before test) | | | | | | |

Table 8 reveals that in Examples 54 to 56 where the one-part curable resin compositions contained the phenolic compound (C), the impact peel performance was better and the T-peel bond strength was higher than in Comparative Examples 21 to 23 where the compositions did not contain the component (C).

It is also seen that the impact peel performance retention rate after moisture heat exposure test was higher in Examples 54 to 56 than in Comparative Examples 21 to 23 and therefore that the cured products obtained in these examples had high moist heat resistance. This is presumably due to the fact that the phenolic compound (C) used had a methyl group and a tertiary alkyl group at ortho positions relative to each phenolic hydroxy group.

| | | | | | | | | | Comparative |
|---|---|---|---|---|---|---|---|---|---|
| | | | | | Examples | | | | Example |
| Component proportions (parts by weight) | | | | | 57 | 58 | 59 | 60 | 24 |
| (A) | Epoxy resin | | A-1 | | 55 | 55 | 55 | 55 | 55 |
| (A) + (B) | Dispersion (M) containing polymer particles (B) | | M-1 | | 75 | 75 | 75 | 75 | 75 |
| | dispersed in (A) | | | | | | | | |
| | Rubber polymer | CTBN 1300 × 8 | | | 5 | 5 | 5 | 5 | 5 |
| (C) | Phenolic compound | 2,3,6-Trimethylphenol | 1^{(*)} | 0^{(**)} | 4.5 | | | | |
| | | 3-Methyl-6-tert-butylphenol | 1^{(*)} | 1^{(**)} | | 5.5 | | | |
| | | 2-Methyl-6-tert-butylphenol | 1^{(*)} | 1^{(*)} | | | 5.5 | | |
| | | 2,6-Di-tert-butylphenol | 1^{(*)} | 2^{(*)} | | | | 6.9 | |

| | | | | | | | |
|---|---|---|---|---|---|---|---|
| (D) | Dicy andiamide | Dyhard 100S | 7 | 7 | 7 | 7 | 7 |
| (F) | Curing accelerator | Dyhard UR200 | 2 | 2 | 2 | 2 | 2 |
| | Fumed silica | TS-720 | 6 | 6 | 6 | 6 | 6 |
| | Calcium carbonate | WHITON SB | 60 | 60 | 60 | 60 | 60 |
| | Carbon black | MONARCH 280 | 0.3 | 0.3 | 0.3 | 0.3 | 0.3 |
| | Calcium oxide | CML #31 | 1.5 | 1.5 | 1.5 | 1.5 | 1.5 |

| | | | | | |
|---|---|---|---|---|---|
| Amount of component (B) per 100 parts of component (A) | 30 | 30 | 30 | 30 | 30 |
| Amount of component (C) per 100 parts of component (A) | 5 | 5 | 5 | 7 | 0 |
| Amount of component (D) per 100 parts of component (A) | 7 | 7 | 7 | 7 | 7 |
| Amount of component (F) per 100 parts of component (A) | 2 | 2 | 2 | 2 | 2 |

| | | | | | |
|---|---|---|---|---|---|
| Ratio of number of moles of phenolic OH groups of component (C) to number of moles of CN | 0.20 | 0.20 | 0.20 | 0.20 | 0.00 |
| groups derived from component (D) | | | | | |
| T-peel bond strength (before moist heat exposure test) (N/25 mm) <23º C.> | 210 | 207 | 210 | 187 | 182 |
| T-peel bond strength retention rate after moist heat exposure test | 0.54 | 0.53 | 0.63 | 0.54 | 0.38 |
| (strength after test/strength before test) | | | | | |
| Dynamic cleavage resistance (kN/m) <23° C.> | 29 | 28 | 29 | 28 | 26 |
| Viscosity increase rate (viscosity after storage/viscosity before storage) | 2.1 | 2.2 | 1.1 | 0.9 | 1 |

Table 9 reveals that in Examples 57 to 60 where the one-part curable resin compositions contained the phenolic compound (C), the impact peel performance was better and the T-peel bond strength was higher than in Comparative Example 24 where the composition did not contain the component (C).

It is also seen that the T-peel bond strength retention rate after moisture heat exposure test was higher in Examples 57 to 60, in particular Example 59, than in Comparative Example 24 and therefore that the cured products obtained in these examples, in particular Example 59, had high moist heat resistance. This demonstrates that it is preferable for the phenolic compound (C) to have substituents at ortho positions relative to the phenolic hydroxy groups in terms of improving the moist heat resistance and that it is particularly preferable for the phenolic compound (C) to have a methyl group and a tertiary alkyl group at ortho positions relative to each phenolic hydroxy group.

It is also seen that for the one-part curable resin compositions of Example 57 to 60, the viscosity increase rate after 14-day storage at 40° C. was low and therefore that these compositions had relatively good storage stability. The storage stability was better in Examples 59 and 60 and particularly high in Example 60. This is presumably due to the number and bulkiness of the substituents located at ortho positions relative to each phenolic hydroxy group.

TABLE 10

| | | Structural formuła | Molecular weight | Melting point (° C.) |
|---|---|---|---|---|
| Component (C) | 4-tert-Butylphenol | 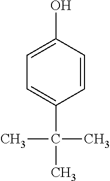 | 150.22 | 101 |
| | Bisphenol A: 2,2-bis(4-hydroxyphenyl)propane | 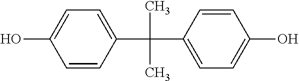 [SMILES: CC(C)(c1ccc(O)cc1)c1ccc(O)cc1] | 228.29 | 156-160 |
| | Bisphenol M: 1,3-bis[2-(4-hydroxyphenyl)-2- propyl]benzene | 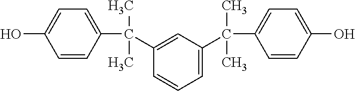 [SMILES: CC(C)(c1ccc(O)cc1)c1cccc(C(C)(C)c2ccc(O)cc2)c1] | 346.47 | 136-140 |
| | Phenol | 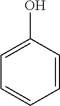 | 94.11 | 41-45 |
| | 4-Methoxyphenoł | 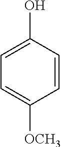 | 124.14 | 55-58 |
| | 2,6-Xylenol | 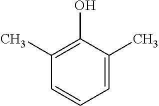 | 122.17 | 44-48 |
| | Resorcinol | 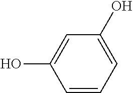 | 110.11 | 110-112 |
| | Catechol | 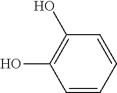 | 110.11 | 105 |
| | 4-tert-Butylcatechol | 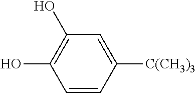 [SMILES: CC(C)(C)c1ccc(O)c(O)c1] | 166.22 | 53-58 |
| | Hydroquinone | 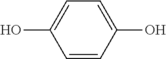 | 110.11 | 172-176 |
| | Methylhydroquinone | 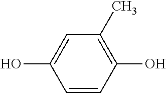 | 124.14 | 126-130 |
| | tert-Butylhydroquinone | 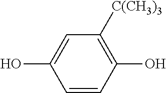 [SMILES: CC(C)(C)c1cc(O)ccc1O] | 166.22 | 127-131 |
| | 2,5-Di-tert-butylhydroquinone | 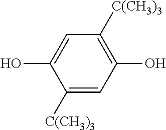 [SMILES: CC(C)(C)c1cc(O)c(C(C)(C)C)cc1O] | 222.33 | 215-222 |
| | 2,2′-Diallyl bisphenol A | 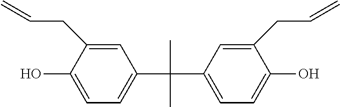 [SMILES: C=CCc1cc(C(C)(C)c2ccc(O)c(CC=C)c2)ccc1O] | 308.41 | Lower than 50 |
| | Pyrogalloł | 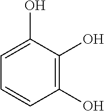 | 126.11 | 130-136 |
| | 3-Methyl-6-tert-butylphenol | 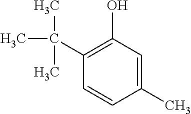 | 164.25 | 21 |
| | 2-Methyl-6-tert-butylphenol | 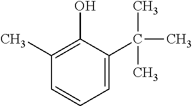 | 164.25 | 28 |
| | [Ethylenebis(oxyethylene)] bis[3- (3-tert-butyl-4-hydroxy-5- methylphenylpropionate)] | 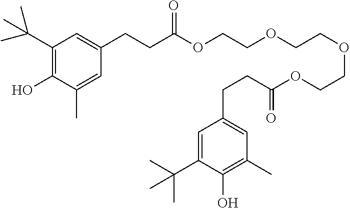 [SMILES: Cc1cc(CCC(=O)OCCOCCOCCOC(=O)CCc2cc(C)c(O)c(C(C)(C)C)c2)cc(C(C)(C)C)c1O] | 586.76 | 76-79 |
| | 6-tert-Butyl-2,4-xylenol | 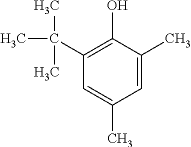 | 178.28 | 20-24 |
| | 2,3,6-Trimethylphenol | 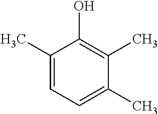 | 136.19 | 62-66 |
| | 2,6-Di-tert-butylphenol | 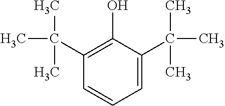 | 206.33 | 35-37 |
| Compound not classifiable as (C) | Anisole | 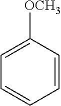 | 108.14 | −37 |
| | 2,4,6- Tris(dimethylaminomethyl)phenol | 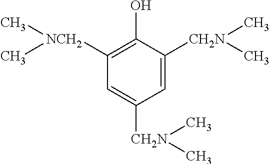 | 265.4 | Liquid |
| | Novolac phenolic resin | 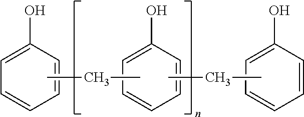 | >500 | |

Although the disclosure has been described with respect to only a limited number of embodiments, those skilled in the art, having benefit of this disclosure, will appreciate that various other embodiments may be devised without departing from the scope of the present disclosure. Accordingly, the scope of the disclosure should be limited only by the attached claims.

1. A one-part curable resin composition comprising:
100 parts by weight of an epoxy resin (A);
1 to 100 parts by weight of core-shell-structured polymer particles and/or blocked urethane as a component (B);
a compound (C) having one to three phenolic hydroxy groups per molecule, the compound (C) not being a compound having one to three phenolic hydroxy groups per molecule and further having an amino group; and
dicyandiamide (D),
wherein a ratio of a number of moles of the phenolic hydroxy groups of the compound (C) to a number of moles of CN groups derived from the dicyandiamide (D) is from 0.01 to 0.39 when the compound (C) has one phenolic hydroxy group per molecule, and from 0.01 to 1.5 when the compound (C) has two or three phenolic hydroxy groups per molecule.

2. The one-part curable resin composition according to claim 1, wherein the compound (C) has one or two phenolic hydroxy groups per molecule.

3. The one-part curable resin composition according to claim 1, wherein the compound (C) has two phenolic hydroxy groups per molecule.

4. The one-part curable resin composition according to claim 1, wherein the compound (C) has one phenolic hydroxy group per molecule.

5. The one-part curable resin composition according to claim 1, wherein the compound (C) has one to four substituents on an aromatic ring, each of the substituents being selected from the group consisting of a methyl group, a primary alkyl group, a secondary alkyl group, a tertiary alkyl group, and a halogen.

6. The one-part curable resin composition according to claim 1, wherein the compound (C) has one or two substituents at ortho positions relative to at least one phenolic hydroxy group, each of the substituents being selected from the group consisting of a methyl group, a primary alkyl group, a secondary alkyl group, a tertiary alkyl group, and a halogen.

7. The one-part curable resin composition according to claim 1, wherein the core-shell-structured polymer particles are contained as the component (B).

8. The one-part curable resin composition according to claim 1, wherein the compound (C) has a molecular weight of 90 to 500.

9. The one-part curable resin composition according to claim 1,
further comprising a compound (E) having four or more phenolic hydroxy groups per molecule,
wherein a ratio of a total weight of the compound (E) to a total weight of the compound (C) is less than 1.

10. The one-part curable resin composition according to claim 1, wherein a ratio of a molar amount of the dicyandiamide (D) to a molar amount of epoxy groups of the epoxy resin (A) is from 0.10 to 0.30.

11. The one-part curable resin composition according to claim 1, further comprising 0.1 to 10 parts by weight of a curing accelerator (F) per 100 parts by weight of the epoxy resin (A).

12. The one-part curable resin composition according to claim 1, wherein each of the core-shell-structured polymer particles has a core layer containing at least one selected from the group consisting of diene rubber, (meth)acrylate rubber, and organosiloxane rubber.

13. The one-part curable resin composition according to claim 12, wherein the diene rubber is butadiene rubber and/or butadiene-styrene rubber.

14. The one-part curable resin composition according to claim 1, wherein each of the core-shell-structured polymer particles has a core layer and a shell layer formed by graft polymerization of at least one monomer component to the core layer, the at least one monomer component being selected from the group consisting of an aromatic vinyl monomer, a vinyl cyanide monomer, and a (meth)acrylate monomer.

15. The one-part curable resin composition according to claim 1, wherein each of the core-shell-structured polymer particles has a shell layer having epoxy groups.

16. The one-part curable resin composition according to claim 1, wherein each of the core-shell-structured polymer particles has a core layer and a shell layer formed by graft polymerization of an epoxy group-containing monomer component to the core layer.

17. The one-part curable resin composition according to claim 1, wherein:
each of the core-shell-structured polymer particles has a shell layer having epoxy groups, and
an amount of the epoxy groups of the shell layer is from 0.1 to 2.0 mmol/g based on a total amount of the shell layer.

18. A cured product resulting from curing of the one-part curable resin composition according to claim 1.

19. An adhesive comprising the one-part curable resin composition according to claim 1.

20. The adhesive according to claim 19, wherein the adhesive is a structural adhesive.

21. A laminate comprising:
two substrates; and
an adhesive layer resulting from curing of the adhesive according to claim 19, the adhesive layer joining the two substrates together.

22. A method for producing the cured product according to claim 18, the method comprising:
mixing the epoxy resin (A), the component (B), the compound (C), and the dicyandiamide (D) to obtain a mixture; and
heating the mixture to obtain the cured product.
